(19) United States
(12) Patent Application Publication
(10) Pub. No.: US 2020/0380461 A1
(43) Pub. Date: Dec. 3, 2020

(54) METHOD AND SYSTEM FOR RECOMMENDING CONFIGURATION OF A CARGO SHIPPING UNIT

(71) Applicant: TRUENORTH SYSTEMS LTD, Tel Aviv (IL)

(72) Inventors: Shlomo Lahav, Ramat-Gan (IL); Efrat Ben-Ami, Tel Aviv (IL)

(73) Assignee: TRUENORTH SYSTEMS LTD, Tel Aviv (IL)

(21) Appl. No.: 16/883,385

(22) Filed: May 26, 2020

Related U.S. Application Data
(60) Provisional application No. 62/854,308, filed on May 29, 2019.

(51) Int. Cl. G06Q 10/08; G06Q 50/28; G06N 7/00

(52) U.S. Cl. CPC G06Q 10/0832; G06N 7/005; G06Q 50/28; G06Q 10/0838

(57) ABSTRACT

The present disclosure describes method and system for recommending configuration of one or more environmental control devices that are associated with a certain cargo shipping unit (CSU) and carries a certain type of cargo. Some example embodiments of the disclosed technique recommend a certain configuration based on the “Wisdom of the crowd” (WOTC) and selects the most popular configuration that is used in similar cases as the recommended configuration. Other example embodiments of the disclosed technique may recommend a configuration that has low probability that damage may occur while using the recommended configuration.

### CROSS-REFERENCE TO RELATED APPLICATIONS

This utility patent application being filed in the United States as a non-provisional application for patent under Title 35 U.S.C. § 100 et seq. and 37 C.F.R. § 1.53(b) and, claiming the benefit of the prior filing date under Title 35, U.S.C. § 119(e) of the United States provisional application for patent that was filed on May 29, 2019 and assigned the Ser. No. 62/854,308, which application is herein incorporated by reference in its entirety. Further, this utility patent application is related to utility patent application U.S. Ser. No. 16/658,138; U.S. Ser. No. 16/658,143; and U.S. Ser. No. 16/658,151 that were all filed on Oct. 20, 2019, which applications are herein incorporated by reference in their entirety. Furthermore, this utility patent application is related to utility patent application U.S. Ser. No. 16/849,195; and U.S. Ser. No. 16/849,952 that were all filed on Apr. 15, 2020, which applications are herein incorporated by reference in their entirety. In addition this utility patent application is related to utility patent application U.S. Ser. No. 16/867,224 that was filed on May 5, 2020, which application is herein incorporated by reference in its entirety.

### FIELD OF THE INVENTION

The present disclosure relates to the field of cargo transportation and more particularly to manage cargo transportation in a cargo shipping unit (CSU) having environmental control devices.

### BACKGROUND OF THE INVENTION

Common cargo transportation is implemented by a shipping unit. An example of a cargo shipping unit (CSU) can be a container, an air parcel, etc. A common CSU provides an enclosed space in which physical items can be stored during shipment. A single journey of a CSU can comprise a plurality of segments. In each segment a different entity can be responsible for the safety of the CSU and its cargo.

An example of a journey of a CSU from an origin (such as but not limited to a factory, a warehouse, a retail outlet, etc.) to a destination (such as but not limited to a warehouse, a retail outlet, a customer premises, etc.) can comprise a plurality of segments. Segments such as but not limited to: loading the goods into the CSU at the shipper's platform; loading the CSU on a truck or a train at the shipper's yard; transporting the CSU toward the port or the airport; off-loading the CSU from the truck or the train; storing the CSU at the port or airport; embarking the CSU on the ship or airplane; transporting the CSU by the ship or the airplane; off-loading the CSU from the ship or airplane; temporary storing the CSU in the port (airport); loading the CSU on a truck or a train; transporting the CSU toward the consignee's yard; and downloading the CSU from the truck to the consignee's platform. Along the disclosure and the claims the terms origin, shipper and supplier can be used interchangeably and the terms destination, consignee, supplier's customer, or customer can be used interchangeably.

A person with ordinary skill in the art of cargo transportation can appreciate that some journeys may comprise all the above segments; other journeys may comprise part of those segments; and some journeys may comprise more segments than the ones that are disclosed above. Yet in some journeys the order of the segments can be other than the above disclosed order. It should be noted that the disclosed segments of a journey are not intended to limit the scope of the inventive concepts in any manner.

In order to prevent losses some of the CSUs are associated with environmental control devices that are configured to keep certain parameters within a certain range. The environmental control devices can be configured to control the temperature in the relevant CSU at a certain range, to keep the humidity in a certain range, to control the concentration of CO2 and the concentration of O2, etc. Those control devices can be associated with a plurality of sensors that are configured to monitors those parameters.

Usually the settings or the configuration of the environmental control devices is done based on the customer request (the requested configuration), which might be written in a bill-of-lading (BoL) of those CSUs. The settings can be based on information that is related to the type of the cargo, independently whether loss occurred to that cargo of a CSU while using that configuration. Along the present disclosure and the claims the terms configuration and group-of-settings can be used interchangeably.

### SUMMARY OF THE DESCRIPTION

The needs and the deficiencies, which are disclosed above in setting the environmental control devices of a CSU, are not intended to limit the scope of the inventive concepts of the present disclosure in any manner. The needs are presented for illustration only.

Example embodiments of the present disclosure seek to provide a novel technique for recommending a certain configuration of the environmental control devices. The novel technique takes into consideration the type of the cargo, the period of the year, the relevant journey of that CSU, etc. A proper configuration of the environmental control devices may reduce the probability that damages nay occur to the cargo.

An example embodiment of the present disclosure may comprise a loss-demand-receiving unit (LDRU), a loss-demand-analyzer unit (LDAU), operational-recommending-unit (ORU), a predictive-model generator (PMG), a risk analyzing unit (RAU) and one or more databases.

An example embodiment of the present disclosure may be associated with one or more external databases that store general information, which is related to cargo transportation. For convenience and clarity of presentation the present disclosure refers to a plurality of databases, each database can be associated with one or more types of information. However, a person with ordinary skill in the art can appreciate that two or more of those databases may be embodied on one or more physical or virtual media. Such media includes, but not limited to, a read/write hard disc, CDROM, Flash memory, ROM, or other memory or storage devices. In some embodiments, one or more DBs can reside over the Internet cloud.

Some examples embodiments of the disclosed technique may communicate with external databases. Databases such as but not limited to: one or more databases (DB) of journeys, one or more DBs of CSUs, one or more DBs of types of cargo, one or more DBs of sensors, one or more DBs that contain weather information, etc. In some embodiments, one or more DBs can reside over the Internet cloud.

Each entry in an example of journey DB can be associated with a course from a shipper to a consignee. In some cases the shipper and/or the consignee premises can be substituted with an appropriate street, city, district, state, etc. depending on the resolution of the current stored data. Some embodiments of the disclosed technique can be configured to improve the resolution of the stored data at the end of each journey. Each course can comprise a plurality of segments. Each segment can be associated with one or more possible carriers.

Each entry in an example of CSU DB may store information about features of a plurality of CSUs. Features such as but not limited to the material from which the CSU is made, the dimension of the CSU, whether the CSU includes environmental control devices, which sensors are associated with the CSU, whether the CSU is sealed to liquid and/or gas, previous damages, etc.

Each entry in an example of cargo DB may store features of a certain type of cargo. Features such as but not limited to cost, sensitivity to shocks, sensitivity to temperature, sensitivity to humidity, sensitivity to CO2, sensitivity to O2, sensitivity to water, does it carry liquid, is the cargo explosive, etc.

Each entry in an example of sensors DB can be associated with a type or a model of a sensor and may comprise the one or more parameters that are measured by the sensor (shock, humidity, temperature, etc.), the sensitivity of the sensor, the range that the sensor can measure, the tolerance of the readings, the sensors' firmware and hardware versions, etc.

An example of weather DB may store information about the weather according to location, and time. The resolution of the time can be seasons, months, day or even the hour.

Some embodiments of the disclosed technique can be configured to update, at the end of a journey, the stored data or to improve the resolution of the stored data in one or more of the DBs. Other embodiments of the disclosed technique can be configured to update the stored data in the DBs or to improve the resolution of the stored data during the journey.

In addition to the one or more external databases, some embodiments of the disclosed technique may comprise internal DBs. The internal DBs may store proprietary information. The proprietary information may comprise historical information. Each entry in the historical DB (HDB) can comprise information related to a journey, information related to the cargo, information related to the type of the CSU, information regarding the setting of one or more environmental control devices that are associated with the CSU for that cargo, etc. In addition, the entry may store an indication whether a demand for loss was filed or not. If a demand for loss was filed, the related stored information may comprise the type of the damage, the extent of loss, the reading of the sensors, etc. The extent of loss can be expressed as the portion of the cargo that was damaged. In addition, an indication whether the loss-demand was approved, by a human (surveyor or otherwise) or not can be stored too.

An example of loss-demand-receiving unit (LDRU) can comprise one or more processors that are embedded in one or more computers. The computer can be Intel NUC, wherein NUC stands for Next-Unit-of-Computing. An example LDRU can be configured to obtain loss-demands forms in one or more formats, one or more units, etc. The obtained forms can be converted to a standard format in order to generate a standardized-loss-detailed report (SLDR). Next the LDRU may deliver the SLDR to the LDAU.

In some embodiments the LDRU can be configured to communicate with a person that currently prepares a demand for loss. In such embodiment the LDRU can be configured to lead the person along the process of filling the one or more forms of the demand for loss.

An example of LDAU may comprise one or more high-end computers with powerful Graphical-Processing Unit (GPU), for example, that is configured to execute one or more machine learning programs (MLP) in order to learn which recommending report to deliver per a certain loss-demand. A non-limiting example of a powerful computer can be “Amazon EC2 P3 Instances” maintained by Amazon Corp. USA and a non-limiting example of an MLP can be based on “TensorFlow” maintained by Google Brain Team USA, etc.

Other embodiments of the disclosed technique may use supervised machine learning algorithm such as but not limited to logistic regression, linear regression, decision tree, random-forest, etc. in order to generate a predictive function that can be used to predict the probability that damage will occur in a certain journey. In such embodiment the LDAU can be configured to calculate the predicted probability for damage and compare it to a certain threshold. If the value of the predicted probability is higher than the threshold, then the demand for loss can be marked as demand for occurred damages otherwise the demand for loss can be marked a suspected demand. Some embodiment of the disclosed technique may select the value of the threshold from a range of 30% to 60%. An example value of the threshold can be 50% probability that the relevant damage can occur. Along the present disclosure and the claims the terms machine-learning program (MLP) and supervised machine learning algorithm can be used interchangeably.

From time to time, every few weeks, one to ten weeks for example, and example of LDAU can be configured to activate a machine-learning program (MLP) in order to scan the stored data in the historical database and to deliver an updated predictive model. The updated predictive model can predict the probability that a certain demand for loss is for real occurred damages/losses or is suspected. This recommendation can be added to the demand for loss before transferring the demand for loss to a human surveyor to be used as additional tool while preparing his report. Some example embodiment of the disclosed technique may use a classifier model instead of a predictive model. Along the present disclosure the claims the terms predictive model and classifier model can be used interchangeably.

In case that demand for loss was justified by the LDAU as it is disclosed in conjunction with FIG. 4 block 434, then an example embodiment of an LDAU may further be configured to determine the extent of loss (EoL). The EoL can be expressed as the percentage of the cargo that was damaged or as a portion of the cargo that was damaged. For example, in cases in which the cargo is panels of marble then the EoL can be the portion of a panel, or the number of panels that were damage divided by the total number of panels, or a combination of the two.

Some example embodiments of LDAU can be configured to predict the liability, which may be associated with a certain Demand-For-Loss (DFL). Wherein the certain DFL was found as a justified DFL by the example of LDAU. In order to calculate the liability that is associated with a justified DFL, an example of LDAU can be configured to retrieve information that is related to the cost of the cargo; number of units that are included; the weight of each unit; the segment of the journey in which the damage occurred; insurance parameters (convention) that is related to that segment.

Based on the retrieved information an example of LDAU can calculate the maximum liability for that justified DFL. Further, based on the calculated EoL that is related to the type of the cargo and the type of damage an example of LDAU can calculate and present the actual liability for the current case. Finally an example of the LDAU can present the two values the maximum calculated liability and the actual liability for the relevant case. Alternatively an example of LDAU may compare between the two values and present the smallest one.

Some embodiment of LDAU can be configured to predict the EoL for an event. An example of such an embodiment can be configured to predict the EoL of the CSUs that are associated with the event. Such EoL can be referred as the accumulated liability of that vehicle for a certain event. For example accumulated liability can be used when a ship was drowned. In such event the accumulated liability can be used to predict the EoL that is related to the relevant ship. It should be noted that some users my use the term accumulated risk instead of accumulated liability. Thus, along the disclosure and the claims the terms accumulated liability and accumulated risk can be used interchangeably.

In order to predict the accumulated liability of a drowning ship an example of LDAU can be configured to scan the HDB in order to fetch the CSUs that their GPS reading indicate that during the time, in which the ship was drowning, was the same as the reading of the GPS of the ship. Based on the bill-of-lading (BoL) of those CSUs the accumulated liability can be predicted.

Some example embodiments of the disclosed technique may be configured to deliver operational recommendations based on the data that is stored in the history DB. Such embodiments may comprise an ORU. A shipper or a carrier that needs to deliver a certain cargo from a point A to point B may load to the ORU the type of the cargo, the origin location and destination, the requested date, requested cost, etc. The ORU may process the information in view of similar journeys that are stored in the history DB and may deliver recommendation how to deliver the relevant cargo with a minimum risk for damage. Some embodiment may deliver duration estimation. The recommendations can refer to the type of CSU, the route of the journey, recommended carriers, ports, etc.

Furthermore, some example embodiments of ORU can be configured to operate in real time or in near-real-time and deliver an alert upon identifying a risky state. Thus, the alert may prevent loss.

Some example embodiments of ORU can be configured to recommend an initial configuration of environmental control devices of a CSU that carries a certain type of cargo. The initial settings can define the range of temperature in the relevant CSU, the range humidity, the concentration of CO2, the concentration of O2, etc. Yet, some example embodiments of ORU can be configured to recommend a single value per the setting of each one of the environmental control devices.

In order to recommend the configuration for a certain type of cargo, an example of ORU can be configured to search the HDB looking for entries that are related to similar type of cargo, those entries can be copied to a temporary DB 9 (TempDB9). Then TempDB9 can be transferred to the queue of PMG with a request to generate per each environmental parameter one or more predictive models that can predict the settings of environmental control devices that are related to that environmental parameter. The generated one or more predictive models for predicting the configuration can be stored in the predicting models DB. Such recommended configuration is based on the “Wisdom of the crowd” (WOTC) and reflects the most popular configuration that is used in similar cases.

Other example embodiments of ORU can be configured to search the HDB looking for entries that are related to similar types of cargo, those entries can be copied to a temporary DB 10 (TempDB10), TempDB10 can comprise entries in which the cargo was damaged and entries in which the cargo was not damaged. Then TempDB10 can be transferred to the queue of PMG with a request to generate, per each group of configurations of the environmental control devices, a predictive model that can predict the probability that damage may occur while using this group of settings.

Next, per each group of settings, the ORU can fetch the generated relevant predicting model, place the values of the setting of each parameter in the group and calculate the probability that a damage may occur. The group of settings that has the lowest probability that a damage may occur can be used as a configuration recommendation for the relevant CSU having a certain type of cargo. Finally the system-configuration-recommendation and the BoL-recommended-configuration can be presented to the customer and allow him to determine the final settings. Along the present disclosure and the claims the term “BoL-recommended-configuration”, the term “requested configuration” and the term “customer requested configuration” can be used interchangeably.

Some example embodiments of the disclosed technique may be configured to process the stored data in the history DB and deliver a risk model. In such embodiments a risk analyzer unit (RAU) can associate a risk factor to one or more carriers, one or more types of CSUs, one or more segments, etc. At the end of processing the relevant information from the historical DB, an example of a RAU can predict the probability for damage along a certain journey. Based on the risk report a shipper or a carrier can determine which plan of a journey to select, which carrier, etc. Along the present disclosure and the claims the terms route of a journey and a plan of a journey can be used interchangeably. In some embodiment of the disclosed technique the risk report may be based on the calculated EoL that is related to the type of the cargo and the type of damage.

An example of a predictive-model generator (PMG) can operate in two modes of operation, learning mode and ongoing mode. The learning mode can be executed after the initialization of the PMG and when the historical DB contains sufficient data to enable the MLP to start preparing a predictive model. During the learning mode new predictive models can be produced. The ongoing mode can be executed after the learning mode and the PMG can be configured to monitor and to tune one or more existing predictive models. Along the present disclosure and the claims the terms predicting and predictive can be used interchangeably.

In some embodiments of the disclosed technique an example of PMG may be configured to generate a predictive model that can predict the extent of loss (EoL). The EoL can be expressed as the percentage of the cargo, which was damaged or as a portion of the cargo that was damaged. For example, in cases in which the cargo is panels of marble then the EoL can be the portion of a panel; or the number of panels that were damage divided by the total number of panels; or a combination of the two.

During the learning mode a number of journeys can be sampled by the PMG in order to define new predictive models. During the ongoing mode the predictive model can be updated.

The foregoing summary is not intended to summarize each potential embodiment or every aspect of the present disclosure, and other features and advantages of the present disclosure will become apparent upon reading the following detailed description of example embodiments with the accompanying drawings and appended claims.

Furthermore, although specific exemplary embodiments are described in detail to illustrate the inventive concepts to a person skilled in the art, such embodiments are susceptible to various modifications and alternative forms. Accordingly, the figures and written description are not intended to limit the scope of the inventive concepts in any manner.

Other objects, features, and advantages of the present invention will become apparent upon reading the following detailed description of the disclosed embodiments with the accompanying drawings and appended claims.

### BRIEF DESCRIPTION OF THE DRAWINGS

Examples of implementations of the present disclosure are described with respect to the following figures in which:

FIG. 1 illustrates a simplified block diagram with relevant elements of an example of a cargo management system that operates according to the disclosed technique;

FIG. 2 schematically illustrates a flowchart showing relevant processes that can be implemented for collecting data to be stored in a historical database;

FIG. 3 schematically illustrates a flowchart showing relevant processes that can be implemented by an example predictive-model generator (PMG) for generating a predictive model that can be used by LDAU or ORU;

FIG. 4A schematically illustrates a flowchart showing relevant processes that can be implemented by an example of LDAU for analyzing whether a demand for damage is for real occurred damages and indicating on one or more suspected segments of the journey in which the damage may occur;

FIG. 4B schematically illustrates a flowchart showing relevant processes that can be implemented by an example of LDAU for determining the cause for a justified damages;

FIG. 4C schematically illustrates a flowchart showing relevant processes that can be implemented by an example of LDAU for predicting the extent of loss (EoL) for a justified damage;

FIG. 4D schematically illustrates a flowchart showing relevant processes that can be implemented by an example LDAU for determining the liability that is associated with a certain DFL.

FIG. 5A schematically illustrates a flowchart showing relevant processes that can be implemented by an example of operational-recommending-unit (ORU) for calculating the impact of each Parameter of Interest (POI) between an original place and a destination of a certain journey;

FIG. 5B schematically illustrates a flowchart showing relevant processes that can be implemented by an example of operational-recommending-unit (ORU) for calculating the probability for a list of risk factors independently of the route.

FIG. 6A schematically illustrates a flowchart showing relevant processes that can be implemented by an example of operational-recommending-unit (ORU) for predicting a configuration for a relevant CSU for its current type of cargo, wherein the predicting is based on Wisdom-Of-The-Crowd (WOTC);

FIG. 6B schematically illustrates a flowchart showing relevant processes that can be implemented by an example of operational-recommending-unit (ORU) for recommending a configuration that has the lowest probability to be associated with a damage for a relevant CSU and for the relevant type of cargo;

FIG. 6C schematically illustrates a flowchart showing relevant processes that can be implemented by an example of operational-recommending-unit (ORU) for presenting a recommended configuration to a shipper; and

FIG. 7 schematically illustrates a flowchart showing relevant processes that can be implemented by an example RAU for determining the risk that is associated with a certain cargo in a certain journey.

### DETAILED DESCRIPTION OF EXAMPLE EMBODIMENTS

Turning now to the figures in which like numerals represent like elements throughout the several views, in which exemplary embodiments of the present invention are described. For convenience, only some elements of the same group may be labeled with numerals. The purpose of the drawings is to describe examples of embodiments and not for production purpose. Therefore, features shown in the figures are chosen for convenience and clarity of presentation only. Moreover, the language used in this disclosure has been principally selected for readability and instructional purposes, and may not have been selected to define or limit the inventive subject matter, resort to the claims being necessary to determine such inventive subject matter.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments may implement the features and functionality described herein in software, firmware, or hardware as desired, including any combination of software, firmware, and hardware.

In the following description, the words “unit,” “element,” “module” and “logical module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, software, hardware, and/or firmware, ultimately resulting in one or more processors programmed to execute the functionality ascribed to the unit or module. Additionally, multiple modules of the same or different types may be implemented by a single processor.

Further, each unit or module can be configured to execute two or more processes in parallel or one after the other. Software of a logical module may be embodied on a computer readable non-transitory medium such as a read/write hard disc, CDROM, Flash memory, ROM, or other memory or storage, etc. In order to execute a certain task a software program may be loaded to an appropriate processor as needed. In the present disclosure the terms task, method, and process can be used interchangeably.

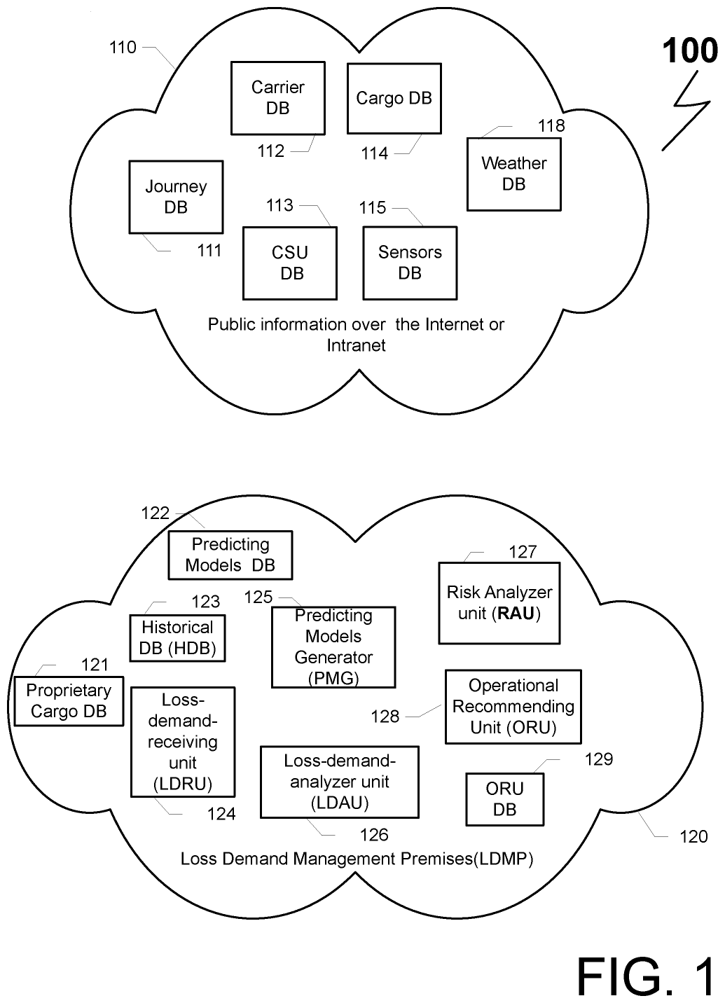

FIG. 1 depicts a simplified block diagram with relevant elements of an example of a cargo management system (CMS) 100 that operates according to the disclosed technique. An example of CMS 100 may comprise a public information network 110 and a proprietary information network 120. The public information network 110 can reside over the Internet, or over a plurality of Intranets (domains) of different entities. Entities may be entities that deliver containers, shipping services, etc.

An example of public information network 110 can comprise a journey DB 111, a carrier DB 112, a CSU DB 113, a cargo DB 114, a sensor DB 115 and weather DB 118. Other example of public information network 110 may comprise part of those DBs or additional DBs, such as but not limited to a shipper's DB (not shown in the figures). The shipper DB may store information related to a certain shipper. Information such as location, type of platform, previous demands for loss, payment history, etc.

Each entry in an example of journey DB 111 can be associated with a course from a shipper to a consignee. In some cases, the shipper and/or the consignee premises can be substituted with an appropriate street, city, district, state, etc. depending on the resolution of the current stored data in the DB 111. Some embodiments of the disclosed technique can be configured to improve the resolution of the stored data at the end of each journey.

Each course can comprise a plurality of segments. Each segment can be associated with one or more possible carriers. Further, per each segment indication can be added about the history of demands for loss that were filed and are related to a certain course or a certain segment. Thus, analyzing the data that is stored in the journey DB 111 may provide insights about the risk that can be associated with a certain course or a segment.

An example of carrier DB 112 may comprise information related to a plurality of carriers. Each entry in the carrier DB 112 may comprise information related to a certain carrier. The carrier can be a sea-carrier, an air-carrier, a train company, a truck company, etc. The information may comprise sizes limitations of CSUs that can be handled by that carrier, weight limitations, scheduling information, possible routes, history of demands for loss that were filed against this carrier and whether the demands were approved or not, etc.

CSU DB 113 may store information about a plurality of CSUs. Each entry in an example of CSU DB 113 may store information about features of certain of CSU. Features such as but not limited to the material from which the CSU is made, the dimension of the CSU, whether the CSU includes environmental control devices, which sensors are associated with the CSU, whether the CSU is sealed to liquid and/or gas, previous damages, etc.

Cargo DB 114 may store information related to a plurality of types of cargo. Each entry in an example of cargo DB 114 may store features of a certain type of cargo. Features such as but not limited to cost, sensitivity to shocks, sensitivity to vibrations (amplitude and frequency), sensitivity to temperature, sensitivity to humidity, sensitivity to water, does it carry liquid, is the cargo explosive, etc. In addition, cargo DB 114 may store information regarding the packaging of the cargo, is it boxes with the dimension and weight of each box. Is the cargo powder inserted in sacks, etc.

Sensors DB 115 may store information related to a plurality of types of sensors. Each entry in an example of sensors DB 115 can be associated with a type or a model of a sensor and may comprise the one or more parameters that are measured by the sensor (shock, humidity, temperature, etc.), the sensitivity of the sensor, the range that the sensor can measure, the tolerance of the readings, etc.

Weather DB 118 may store information related to the weather in a plurality of locations and routes as well as in a plurality of periods of the year. An example of DB 118 can be arranged as a two-dimensional matrix. The first axis can be associated with a location, a segment along a certain route, etc. The second axis can be associated with the month. In such an example of matrix each cell (at a junction of a certain location and a certain month) can include information regarding the weather, the lighting hours, the probability for a storm, etc. Other example embodiments of DB 118 may use other resolution per one or more axis of the matrix. In other examples the resolution of the time axis can be expressed in days and not in months, etc.

Referring now to the Loss-Demand-Management-Premises (LDMP) 120. LDMP 120 can be a private domain of an insurance company or a private domain of a certain shipper, a private domain of a certain carrier, etc. An example of LDMP 120 may comprise one or more private DBs and one or more processing devices. An example of LDMP 120 may comprise: Proprietary-cargo DB 121, Predictive models DB 122, HDB 123, and operational-recommending-unit (ORU) DB 129. In addition, an example of LDMP 120 may comprise few examples of processing devices, devices such as but not limited to: Loss-demand-receiving unit (LDRU) 124, Predictive-models generator (PMG) 125, Loss-Demand-Analyzer unit (LDAU) 126, Risk-analyzer unit (RAU) 127, and Operational-recommending unit (ORU) 128.

An example of the Proprietary-cargo DB 121 may store proprietary information regarding types of cargo. Each entry in an example of DB 121 may store features of a certain type of cargo. Features such as but not limited to cost, sensitivity to shocks, sensitivity to vibrations (amplitude and frequency), sensitivity to temperature, sensitivity to humidity, sensitivity to water, does it carry liquid, is the cargo explosive, etc. In addition, each entry may comprise proprietary information which is related to loss-demands that were filed in relation to the relevant type of cargo. Information such as but not limited to how many loss demands were filed for this type of cargo, the percentage of journeys in which a loss demand was filed related to this type of cargo, the setting of the environmental control devices in journeys that are related to the loss demand, reading of the sensors that are related to the loss demand, etc.

The historical DB (HDB) 123 may store information that was gathered during the years of operational of the owner of the domain 120. The HDB 123 can be used for building predictive models that can predict the probability for a demand for loss along a certain journey. In some embodiments the HDB 123 can be used for building predictive models that can predict the configuration of the environmental control devices along a certain journey.

Each entry in the HDB 123 can comprise information related to a journey from an origin to a destination, information related to the type of cargo and the target features of that cargo, information related to the type of the CSUs, information regarding the setting (configuration) of one or more environmental control devices that are associated with that CSU for that cargo, information regarding the segments of the relevant journey, information regarding different carriers that can be used along the journey, etc.

In addition, each entry in HDB 123 may store indication whether a demand for loss was filed. If a demand for loss was filed, then the related stored information may comprise the type of the damage, the reading of the sensors, the setting of the environmental control devices, etc. In addition, an indication whether a human surveyor found the demand for loss as a valid demand and what is the relevant value of the loss or damage. Periodically, the HDB 123 can be updated with information that was gathered during the current period of time. Further, the information that is stored in the HDB 123 can be used for producing or updating one or more predictive models that can predict the probability that a demand for damages will be filed in a future similar journey. In some embodiments the data can be used for recommending certain setting of environmental control devices.

In some embodiments of the disclosed technique data stored in HDB 123 can be updated in real time or near real time with information that is related to CSU that are currently in a journey. The up to date information can comprise the reading of the sensors that are associated to the relevant CSU.

An example of predictive models DB 122 may store a plurality of predictive models that were produced by the owner of the LDMP 120. Each predictive model can be used for calculating the probability for damage along a certain journey. The parameters that can be used in a predictive model can refer to the type of cargo, the type of CSU, the carrier, the course, segments in the course, the date, etc. The stored predictive models can be used by one or more of the processing units of LDMP 120. In some embodiments of the disclosed technique the predictive models DB 122 may store one or more predictive models that are configured to recommend certain configuration of environmental control devices that are associated with a CSU that carries a certain type of cargo.

An example of ORU DB 129 may store a plurality of operational recommendations to be used by the owner of the LDMP 120. Each entry in the ORU DB 129 may store recommendation that can be used for planning a certain journey of a certain type of cargo. The recommendation can point on a certain carrier, a certain route from the origin to destination, the predicted duration of each route, a certain location on the ship, recommended price for such combination of routes, carrier and cargo type, etc. In some embodiments of the disclosed technique the ORU DB 129 may store recommending configuration of environmental control devices that are associated with a CSU that carries the relevant type of cargo.

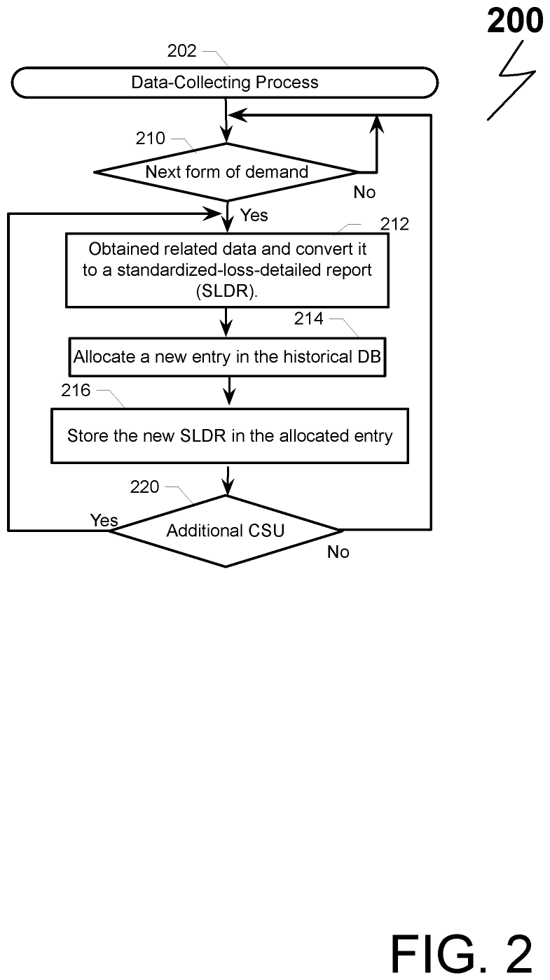

An example of loss-demand-receiving unit (LDRU) 124 can comprise one or more processors that are embedded in one or more computers. The computer can be Intel NUC, wherein NUC stands for Next-Unit-of-Computing. An example LDRU 124 can be configured to obtain loss-demands submission in one or more formats, one or more units (kilogram, tons, pound, dollars, yen, kilometer, mile) etc. The obtained submissions can be converted to a standard format in order to produce a standardized-loss-demand report (SLDR). Next the LDRU 124 may deliver SLDR to a queue of the LDAU 126. More information regarding an example process for data collecting by an example of LDRU 124 is disclosed below in conjunction with FIG. 2. In some embodiments of the disclosed technique the LDRU 124 may be configured to obtain demand for a configuration of environmental control devices that are associated with a CSU that carries the relevant type of cargo.

From time to time, every few weeks one to ten weeks for example, and example of PMG 125 can be configured to activate a machine-learning program (MLP) in order to scan the stored data in the HDB 123 and to deliver an updated predictive model to be stored in the predictive models DB 122. The updated predictive model can predict the probability that damage actually occurred. In some embodiments of the disclosed technique the PMG 125 may be configured to activate a machine-learning program (MLP) in order to scan the stored data in the HDB 123 and to deliver an updated predictive model for predicting the configuration of environmental control devices that are associated with a CSU that carries the relevant type of cargo. The updated model can be stored in the predictive models DB 122.

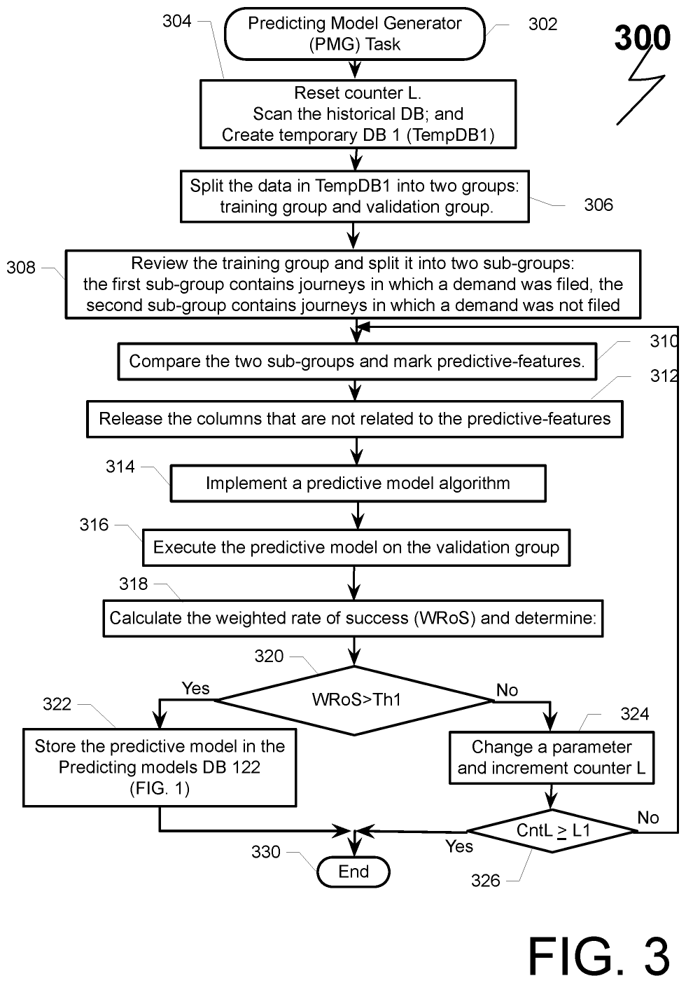

In some example embodiments of the disclosed technique PMG 125 may be configured to generate a predictive model that can predict the extent of loss (EoL). The EoL can be expressed as the percentage or portion of the cargo, which was damaged. For example, in cases where the cargo comprises panels of marble or glass, then the EoL can express the portion of a panel that was damaged; or the number of panels that were damaged divided by the total number of panels; or a combination of the two. A person having ordinary skill in the art can appreciate that adapting the operation of PMG 125 to generate a model for predicting the EoL for a certain type of damage of a certain type of cargo, can be done by modifying few blocks of method 300 (FIG. 3) as it is disclosed below.

An example of predictive-model generator (PMG) 125 can operate in two modes of operation, learning mode and ongoing mode. The learning mode can be executed after the initialization of the PMG 125 and when the HDB 123 contains sufficient data to enable an example of an MLP to start preparing a predictive model for a certain journey and a certain type of cargo. Example embodiments of PMG 125 may use supervised machine learning algorithm such as but not limited to logistic regression, linear regression, decision tree, random-forest, etc. in order to create a predictive function that can be used to predict the probability that damage will occur in a certain journey. More information regarding the operation of PMG 125 is disclosed below in conjunction with FIG. 3.

The ongoing mode can be executed after the learning mode and may monitor and fine-tune one or more existing predictive models that are stored in predictive model DB 122. An example of PMG 125 can be implemented by Intel NUC, or “Amazon EC2 P3 Instances” maintained by Amazon Corp. USA, etc.

An example of LDAU 126 can be a high-end computer with powerful Graphical-Processing Unit (GPU) that is configured to execute one or more MLPs for analyzing standardized-loss-demand report (SLDR), obtained from the LDRU 124, and recommending whether the demand for loss is for real occurred damages or not and may recommend the value of the loss. A non-limiting example of LDAU 126 can use “Amazon EC2 P3 Instances” GPU, which is maintained by Amazon Crop USA. A non-limiting example of a MLP can be based on “TensorFlow” maintained by Google Bain Team USA, etc.

In some embodiments the LDAU 126 can be configured to scan the predictive models DB 122 looking for a valid predictive model that can apply to a current case. If a valid model does not exist, then the LDAU 126 may request the PMG 125 to prepare such a predictive model.

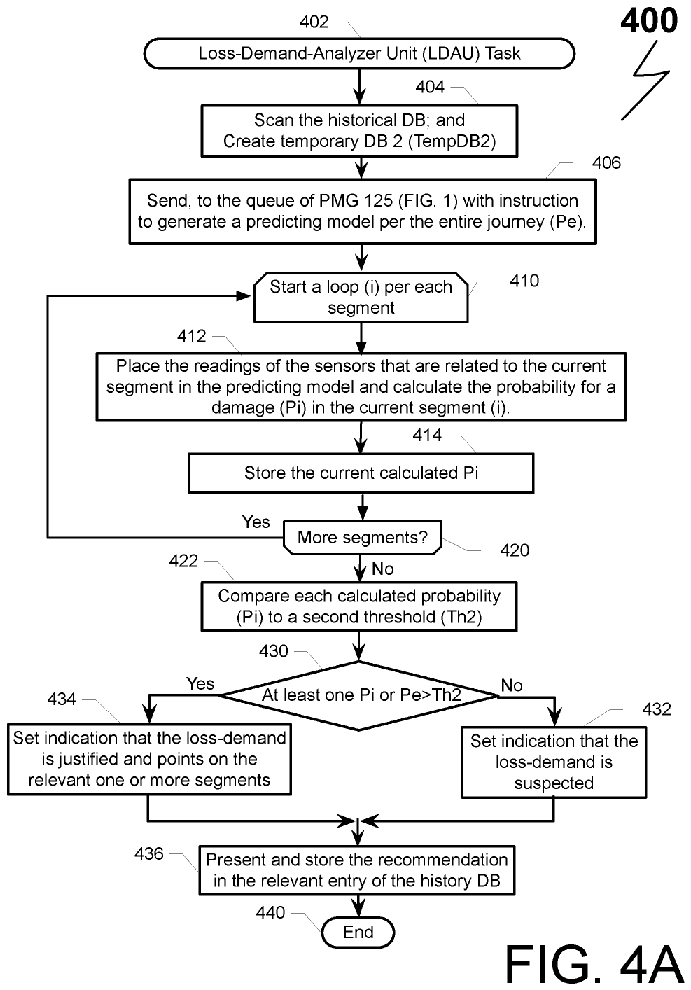

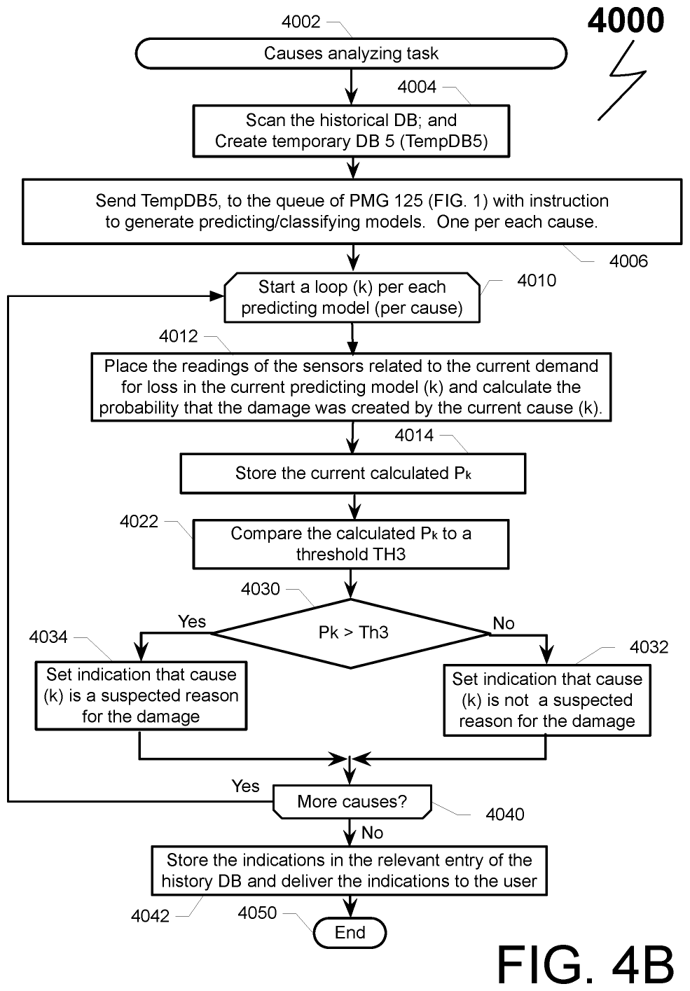

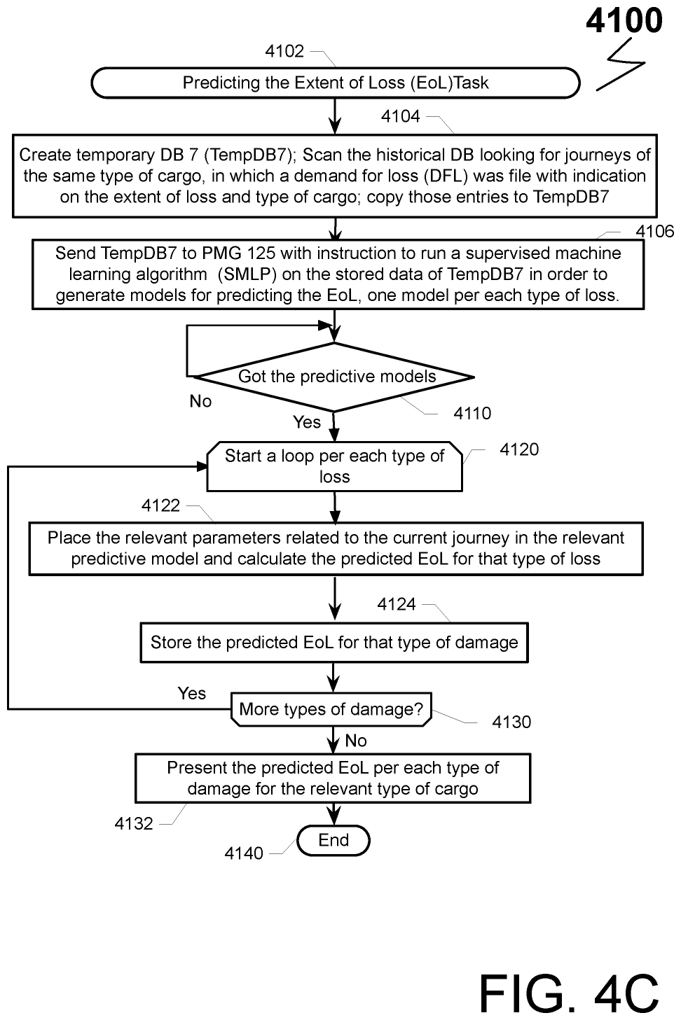

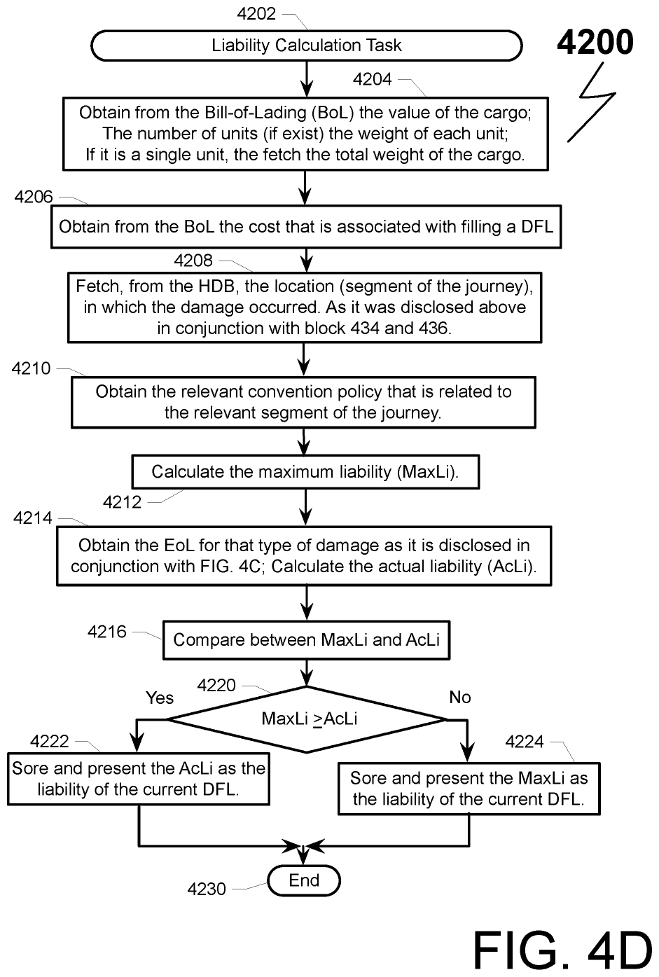

Upon obtaining an appropriate predictive model, LDAU 126 may calculate the predicted probability for damage and compare it to a certain threshold. If the value of the predicted probability is higher than the threshold, then the demand for loss can be marked as demand for occurred damages, otherwise the demand for loss can be marked a suspected demand one. Some embodiment of the disclosed technique may select the value of the threshold from a range of 30% to 60%. More information about the operation of LDAU 126 is disclosed below in conjunction with FIG. 4A to 4C.

The recommendation of the LDAU 126 can be added to the SLDR before transferring the SLDR to a human surveyor to be used as additional tool while preparing his report. Some example embodiment of LDAU 126 may use a classifier model instead of a predictive mode. Along the present disclosure the claims the terms predictive mode and classifier model can be used interchangeably.

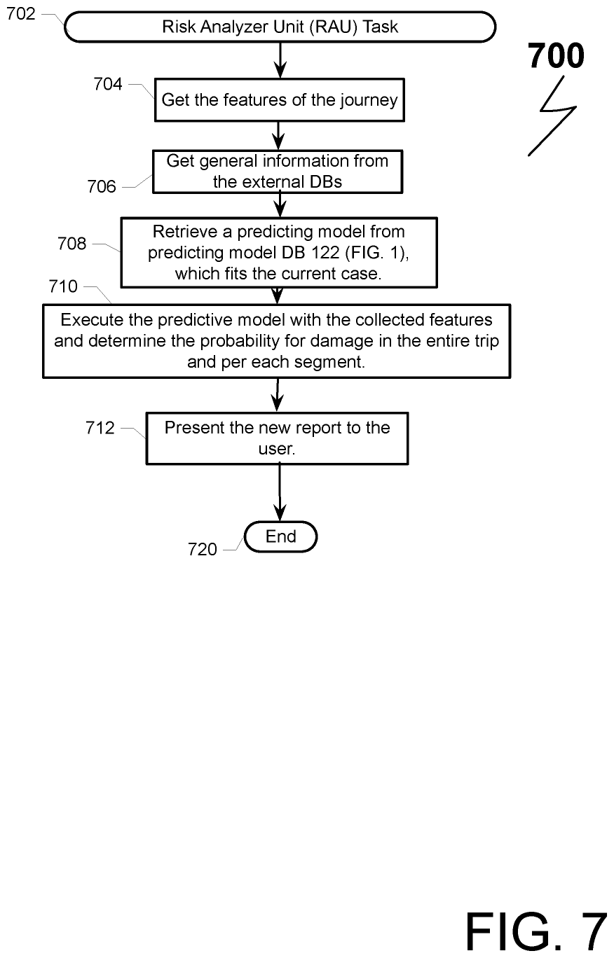

Some example embodiments of risk analyzing unit (RAU) 127 can be configured to process the stored data in the HDB 123 and deliver one or more predictive models that can be used for predicting the probability for damage along a certain journey for a certain type of cargo at a certain period of the year. In such embodiments the risk analyzer unit (RAU) 127 can associate a risk factor to one or more carriers, one or more types of CSUs, one or more segments, etc. Based on the risk report a shipper can determine via which route to transfer the shipment, by which carrier, to determine the shipping cost in view of the risk factor, etc. More information about the RAU 127 is disclosed below in conjunction with FIG. 7.

An embodiment of ORU 128 may be configured to deliver operational recommendations based on the data that is stored in the HDB 123. A shipper that needs to deliver a certain cargo from a first place to a second place may deliver to the ORU 128 the type of the cargo, the origin location and destination, the requested date, requested cost, etc. The ORU 128 may process the information in view of similar journeys that are stored in the HDB 123 and may deliver recommendation how to deliver the relevant cargo with a minimum risk for damage. The recommendations can refer to which type of CSU to use, which route to select, recommended carriers, recommended ports, recommendations where to put the CSU, etc.

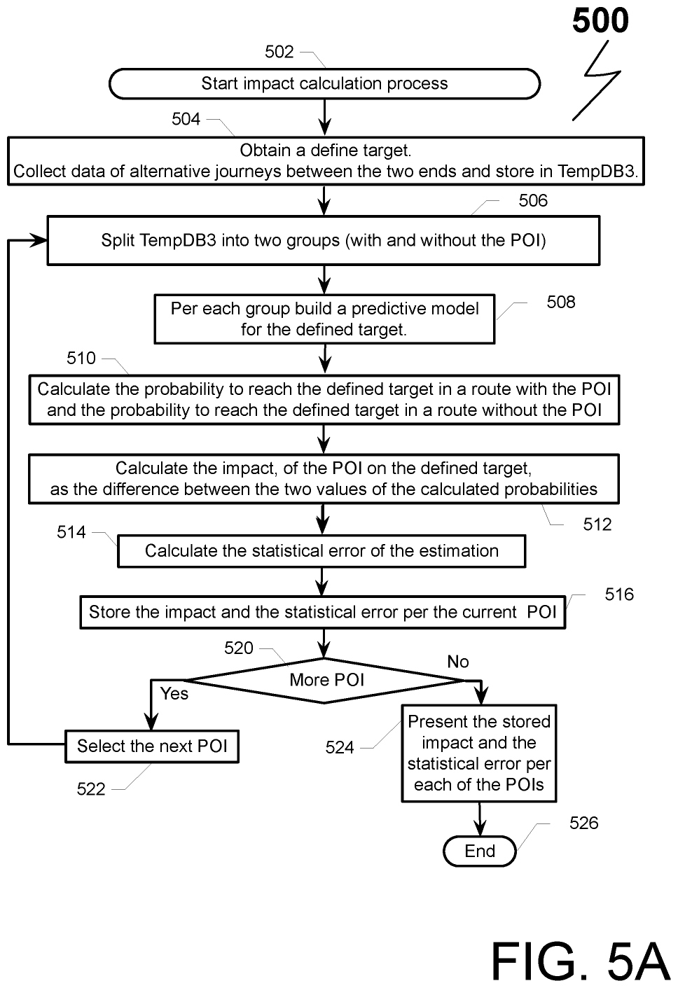

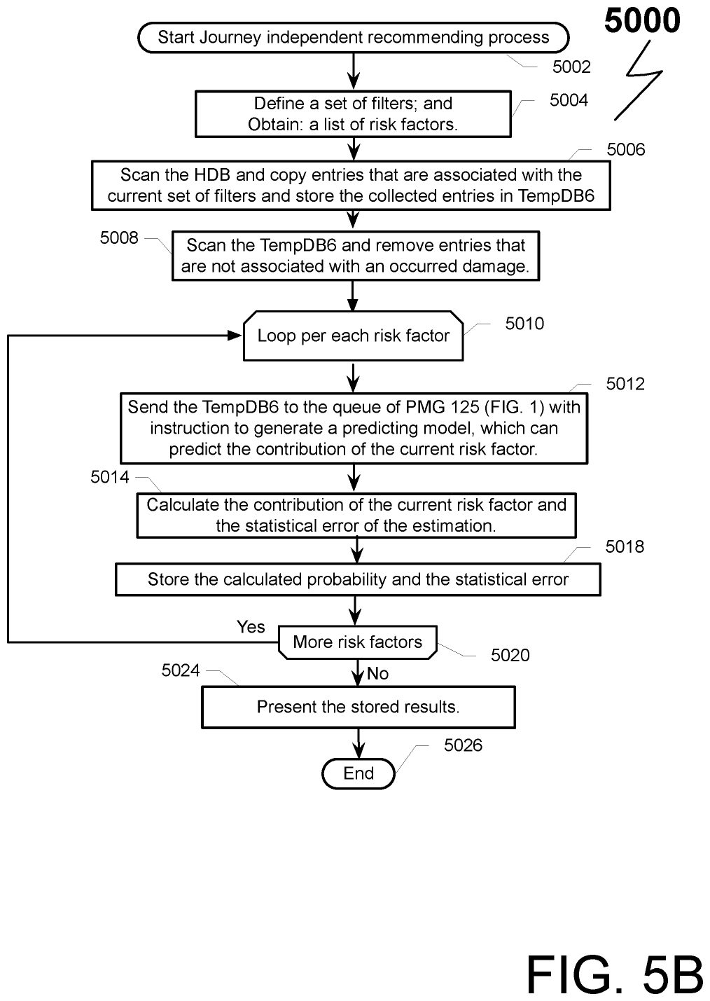

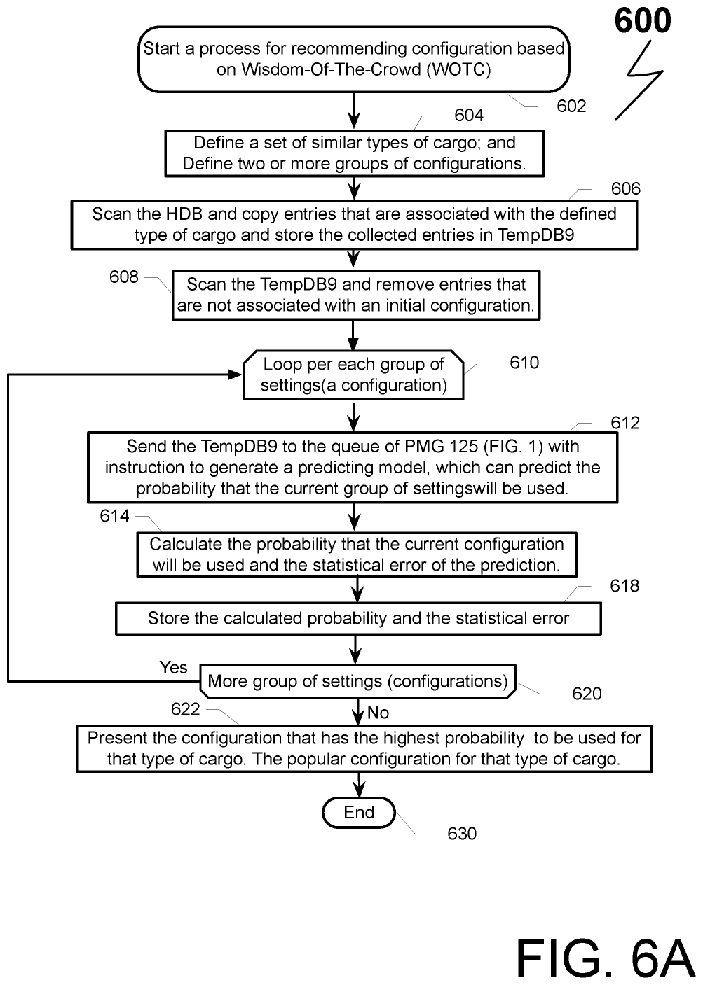

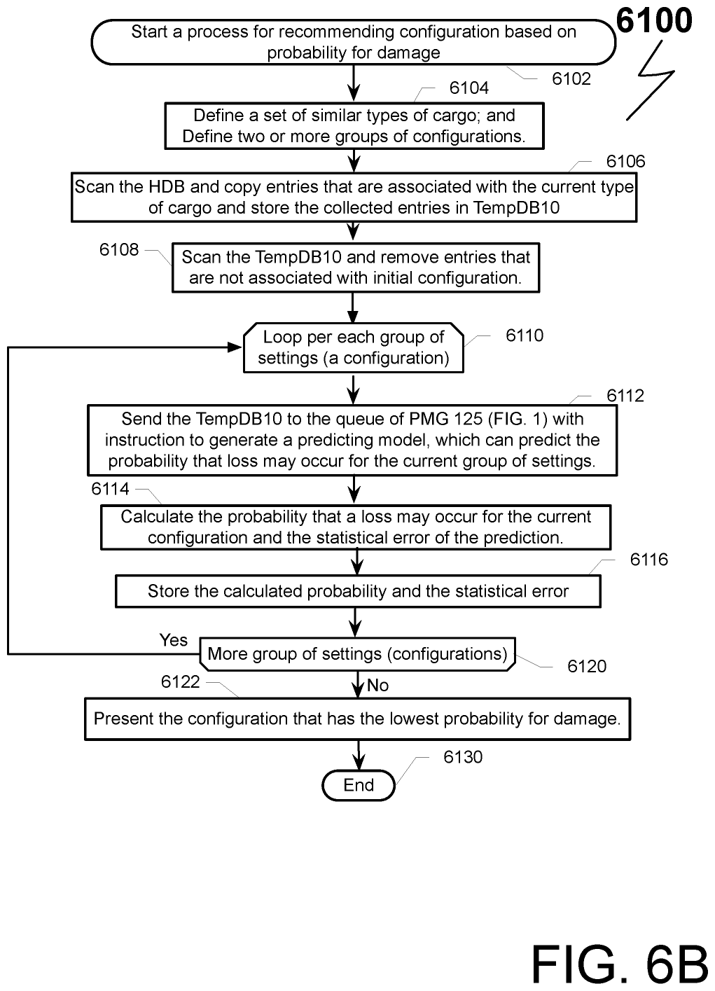

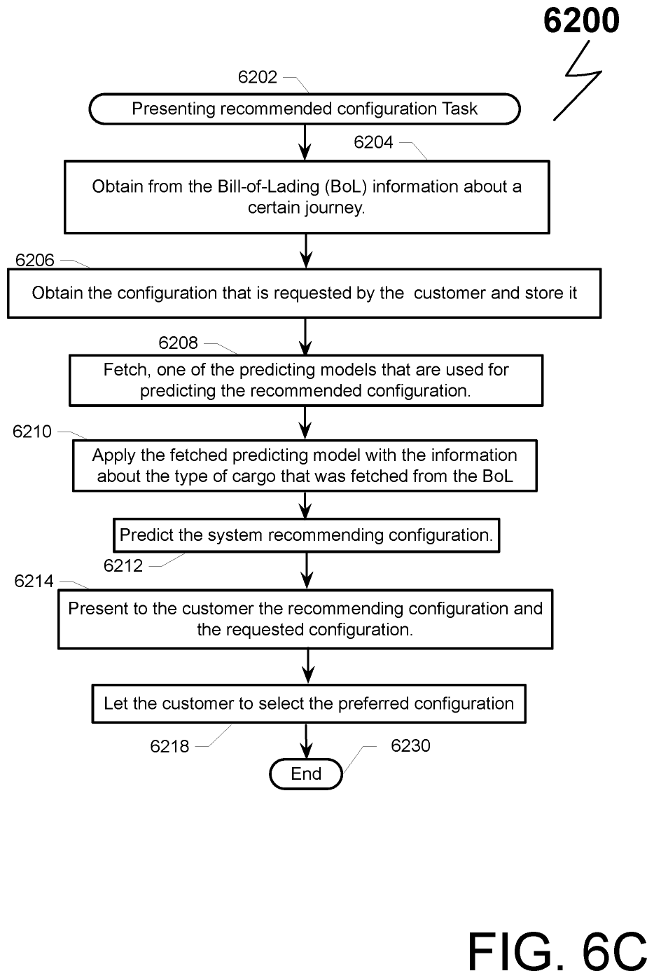

In some embodiment of the disclosed technique the ORU 128 may deliver recommendation how to configure one or more environmental-control devices that are associated with the selected CSU. The recommendation takes into consideration the needs of the cargo. The environmental control devices can control the humidity, the concentration of CO2, the concentration of O2, the temperature, etc. Those control devices can be associated with a plurality of sensors that are configured to monitors those parameters. More information about the operation of examples ORU 128 is disclosed below in conjunction with FIG. 5A, 5B and FIG. 6A, 6B, 6C, 6D.

Some example embodiments of ORU 128 can be configured to operate in real time or in near-real-time and upon identifying a risky state ORU 128 may alert. Thus, the alert may prevent loss. A risky state can be defined by ORU 128 as a combination of a plurality of parameters. A risky state can be identified when the value of each one of the following parameters reside in a certain range. For fruit the parameters can be temperature; humidity; concentration of O2 or CO2; and duration, for example.

For panels of glass or marble a risky state can be defined by combination of amplitude of vibration; with frequency of the vibration and with the duration that those parameters exceeds a certain level, for example. Thus, a risky zone for a certain type of cargo can be defined as a space that is limited by a plurality of factors. In order to activate an alert in real time or near real time, sensors, which are associated with CSUs that are managed by the disclosed system, need to have capabilities to transfer their reading in real time to a DB that is associated with the disclosed cargo management system 120.

An example embodiment of system 120 can be configured to obtain the values of one or more thresholds from the relevant bill-of-lading (BoL). Alternate embodiments of the disclosed technique can be configured to analyze the data that is stored in the HDB 123 and accordingly to take care that one or more predictive models will be generated. Predictive models that can predict the probability that a current state is risky. In such embodiment the ORU 128 can be configured to scan the HDB 123 looking for entries that are related to a similar type of cargo and copy those entries to a temporary DB 8 (TempDB8), for example.

TempDB8 can comprise entries in which the cargo was damaged and entries in which the cargo was not damaged. Then, TempDB8 can be sent to the queue of PMG 125 with a request to generate one or more predictive models that can predict whether the situation, in which the cargo currently resides, approaches a risky state. The generated one or more predictive models for predicting a risky state can be stored in the predicting models DB 122.

The generated one or more predictive models for predicting risky state can be used by the ORU 128 in order to alert, in real time or near real time, that a current state, of a certain cargo in a certain CSU, is approaching or in a risky zone, in which a damage may occur.

Such an example embodiment of ORU 128 can be configured to scan periodicity or in cyclic mode the CSUs, which are currently supervised by the disclosed cargo management system 120. Per each CSU and based on the type of cargo one or more predictive models for alerting can be fetched. Next, the current values of the sensors that are associated with the relevant CSU can be obtained and be placed in the relevant predictive model in order to calculate the probability that damage may occur. The obtained values of the sensors are related to real time or near real time reading of the sensors.

In case that the predictive probability for approaching a risky zone is above a certain threshold, then an alert can be activated. The alert can be activated at headquarter of the carrier in order to invoke one or more actions that can terminate the risky state and prevent a damage that may occur to the cargo. Example of values of the threshold for the probability that a loss may occur can be few tens of percentages, 60-90% for example. A common value can be 70% probability that damage may occur in order to alert.

Some example embodiments of ORU 128 may be configured to determine the increasing rate in which the probability that a risky state may occur, and accordingly can be configured to activate the alert.

In parallel to activating the alert, an example embodiment ORU 128 can be configured to initiate a process for sending a replacement CSU. The replacing CSU may carry the same cargo. Such an embodiment keeps the customer satisfaction by reducing the time interval between the arrival of the cargo that was in a risky state and might be affected and obtaining replacement lading.

Some example embodiments of ORU 128 may be configured to recommend an initial configuration of the environmental control devices of a CSU that carries a certain type of cargo. The initial settings can define the temperature in the relevant CSU, the humidity, the concentration of CO2, the concentration of O2, etc.

In order to recommend the configuration for a certain type of cargo, an example of ORU 128 can be configured to search the HDB 123 looking for entries that are related to similar type of cargo, those entries can be copied to a temporary DB 9 (TempDB9), TempDB9 can comprise entries in which the cargo was damaged and entries in which the cargo was not damaged. Similar types of cargo are used in order to increase the number of observations to be used. The similarity can be based on the types of damage that can occur to this type of cargo. For example fruits can be a group that comprises: apples, bananas, oranges, etc. This group can be frozen, ripening, rottenness, physical damages, etc. Other similar type of cargo can comprise panels of marble or glass. The common damage can be cracks, scratches or a combination of them, etc.

Then TempDB9 can be transferred to the queue of PMG 125 with a request to generate per each environmental parameter one or more predictive models that can predict the popular settings of environmental control devices that are related to that environmental parameter. The generated one or more predictive models for predicting the popular configuration can be stored in the predicting models DB 122. Such recommended configuration is based on the “Wisdom of the crowd” (WOTC). More information regarding the operation of ORU 128 that is related to WOTC is disclosed below in conjunction with FIG. 6B.

Some example embodiments of ORU 128 can be configured to search the HDB 123 looking for entries that are related to similar type of cargo, those entries can be copied to a temporary DB 10 (TempDB10), TempDB10 can comprise entries in which the cargo was damaged and entries in which the cargo was not damaged. Then TempDB10 can be transferred to the queue of PMG 125 with a request to generate per each group of configurations of the environmental control devices a predictive model that can predict the probability that damage may occur while using this configuration.

Per each configuration, the ORU 128 can fetch the generated relevant predicting model from the predicting models DB 122, place the values of the setting of each parameter in the configuration and calculate the probability that damage may occur. The group of settings (configuration) having the lowest probability that damage may occur can be used as a configuration recommendation for the relevant CSU having that type of cargo. Finally the system-configuration-recommendation and the requested configuration can be presented to the customer and allow him to determine the final settings. More information regarding the operation of ORU 128 that is related to damage-based-recommendation is disclosed below in conjunction with FIGS. 6C and 6D.

Referring now to FIG. 2 that illustrates a flowchart of a process 200 for collecting data of a new case to be stored in the historical database (HDB) 123. Process 200 can be implemented by LDRU 124. Method 200 can be initialized 202 after power on, and may run in a loop as long as the LDRU 124 is active.

After initiation 202 process 200 may wait 210 to obtain a next form of a demand for loss. The form can comprise information such as but not limited to: date, cargo type; CSU type, origin, destination, number of segments, per each segment: date origin, destination, carrier, loss Y/N; configuration of the environmental control devices that are associated with the CSU, reading of the sensors, the decision of a surveyor that check the demand, the cause of damage, etc. However, similar features of different forms can be expressed in different units. Therefore, the LDRU 124 may convert 212 the obtained form into a SLDR.

An example of SLDR can be a matrix in which the columns can be related to: locations (origin, destination), parameter of interest (POI), segments of the journey, carriers, time, type of CSU, associated environmental control devices, used configuration of the environmental control devices, a column per each associated sensor, a column that indicates whether a demand for loss was filed, the value of the demand, the decision of a human surveyor etc. The lines in the matrix can be associated with relevant CSUs. The POI can be the origin, destination, ports along the way, warehouses, cost of journey etc.

Similar parameters (features) in the SLDR are expressed by the same units. Following are few examples: the temperature can be presented in Celsius degrees; weight can be presented in Kilogram. Meter per second squared can be used for acceleration, etc. Columns that are associated to missing features can be remained empty.

Next, a new entry in the HDB 123 can be allocated 214 by LDRU 124 and the new SLDR can be stored 216 in that entry. At block 220 a decision is made whether additional CSU is included in the current form of the demand. If 220 yes, then process 200 returns to block 212 for handling the next CSU. If 220 there are no additional CSUs, then process 200 may return to block 210 for handling the next demand for loss or may wait 210 to obtain a new demand. In some example embodiments the entry can be updated with the decision of the LDAU 126 whether the demand is justified or not, as it disclosed below in conjunction with FIG. 4 block 436.

FIG. 3 illustrates a flowchart with relevant processes of an example of method 300 that can be used for generating a predictive model. Method 300 can be implemented by PMG 125 (FIG. 1), for example. Some embodiments of PMG 125 can be configured to generate a predictive model that can predict a recommended configuration for a certain type of CSU and for a certain type of cargo.

Method 300 can be initialized 302 by LDAU 126 (FIG. 1) in order to generate a predictive model to be used for predicting whether a demand for loss (DFL) is justified or not. As it is disclosed below in conjunction with block 406 FIG. 4A. In addition process 300 can be initialized 302 by LDAU 126 (FIG. 1) in order to generate a predictive model to be used for predicting the EoL of a certain type of cargo and a certain type of damage as it is illustrates in block 4106 FIG. 4C.

Further, in some embodiments of the disclosed technique, process 300 can be initiated 302 by the ORU 128 (FIG. 1) for predicting a recommended-configuration (a group of setting) of environmental-control-devices to be used for a certain CSU and for a certain type of cargo as it is disclosed below in conjunction with FIG. 6B block 6012.

Furthermore, some example embodiments PMG 125 can be configured to periodically update one or more predictive models that are stored in the predicting model DB 122 (FIG. 1). Example of update periods can comprise few weeks, between one to five weeks, two weeks for example.

At block 304 method 300 may reset a counter that counts the number of loops to be executed by PMG 125 in order to build a predictive model. This counter can be referred as counter L (CntL), thus the value of CntL=0. Next PMG 125 may scan 304 the HDB 123 (FIG. 1) looking for entries that are related to similar journeys. The similarity can be based on locations, segments, carriers, type of CSUs, type of cargo, dates, weather, etc. Those entries are copied 304 to a temporary database 1 (TempDB1).

It should be noted that a person having ordinary skill in that art will appreciate that copy of relevant entries from the HDB 123 (FIG) to a temporary DB can be done by just storing a link for a relevant entry in the HDB in an appropriate entry of the temporary DB.

Next, PMG 125 can split 306 the TempDB1 into two groups, a training group and a validation group. Usually the training group has more entries than the validation group. An example of a training group can have 70% to 99% of the entries of TempDB1. A common training group can have the oldest 90% of the entries of TempDB1.

At block 308 the training group can be divided into two sub-groups. The first sub-group can comprise journeys (entries of TempDB1) in which a DFL was filed. The second sub-group can comprise journeys (entries of TempDB1) in which a DFL was not filed. Next, process 300 may initiate a loop from block 310 to block 326. Each cycle of the loop is related to build a predictive model and checking it.

In example embodiment of process 300, which is configured to predict a recommended configuration of the CSU, block 308 can be modified to divide the training group into two or more sub-groups. Each sub-group can be associated with a possible configuration of the environmental control devices that are associated with the CSU.

Next, process 300 may initiate a loop from block 310 to block 326. Each cycle of the loop is related to build a predictive model and checking it. At block 310 the sub-groups are compared in order to mark one or more predictive-features. The predictive-features are features (columns in the first sub-group) having values that are substantially dissimilar from the values of the same features in the other sub-group. Features that emphasis the variance between the sub-groups. Next, the features (columns) that are not marked as predictive-features can be released 312 from the sub-groups.

At block 314 PMG 125 may execute a supervised machine learning algorithm that process the numbers in the sub-groups in order to build a predictive model. Algorithms such as but not limited to logistic regression, linear regression, decision tree, random forest, etc. Then, at block 316 the predicted model is executed on the validation group and the weighted rate of success (WRoS) can be calculated 318. The rate of success can be calculated by counting the number of journeys, from the validation group, in which the predictive model succeeded in predicting that a DFL will be filed divided by the amount of journeys that are included in the validation group. The WRoS takes into consideration the relation between the sizes of each sub-group (the size of the sub-group in which a DFL was filed and the size of the sub-group in which a DFL was not filed.

In order to generate a predictive model that can predict a recommended configuration block 314 may be modified to execute a supervised machine learning algorithm that process the numbers in the sub-groups in order to build the required predictive model. Algorithms such as but not limited to logistic regression, linear regression, decision tree, random forest, etc. Then, at block 316 each predicted model may be executed on the validation group and the weighted rate of success (WRoS) can be calculated 318.

The rate of success can be calculated by counting the number of journeys, from the validation group, in which the predictive model succeeded in predicting that configuration divided by the amount of journeys that are included in the validation group. The WRoS takes into consideration the relation between the sizes of each sub-group (the size of the sub-group in which that configuration was used and the size of the sub-group in which it was not used.

Next, a decision is made 320 whether the value of WRoS is greater than the value of a first threshold (Th1). Th1 can be a parameter above few tens of percentages, above 40%. An example value of Th1 can be 65%. If the WRoS is higher than Th1, then the calculated predictive model can be considered as a valid model and be stored 322 in the predictive model DB 122 (FIG. 1) and process 300 can be terminated 330.

If the value of WRoS is smaller or equal to Th1, then the value of one or more parameters can be changed 324. The parameters can comprise the value of Th1, the size of each sub-group, etc. In addition, CntL can be incremented 324 by one and a decision can be made 326 whether the value of CntL is greater or equal to a threshold L1. L1 can represent the maximum number of loops that can be implemented in order to define a predictive model. L1 can be in the range of two to five loops for example. A common value of L1 can be 3 times.

If 326 the value of CntL is equal or greater than L1, then process 300 can set an indication that a predictive model cannot be generated for the current case and process 300 can be terminated 330. If the value of CntL is smaller than L1, then process 300 returns to block 310 and execute another cycle of the loop for generating a predictive model.

In cases in which a certain predictive model fit two or more types of cargo, then at block 312 features, which can be used for both types, can be marked as interactive features or compound features. In an alternate example embodiment of process 300, at end of block 326, the PMG creates L1 predictive models. In such embodiments, the L1 predictive models can be ensemble into a single predictive model which is a weighted average of the L1 models.

In order to create a model for predicting the EoL, an example of PMG 125 may be configured to modify block 304 to obtain the TempDB7 that was created and be transferred to PMG 125 by LDAU 124 (FIG. 1) at blocks 4104 and 4106 (FIG. 4C). If a plurality of types of damage exists, then PMG 125 can be configured to generate a predictive model per each type of damage. Thus, process 300 can be modified to execute blocks 306 to 330 per each type of damage. After storing 322 the one or more predictive models for determining the EoL per each type of damage, an indication can be sent to process 4100 block 4110 (FIG. 4C) with a pointer to the stored one or more predictive models for determining the EoL, one per each type of damage.

Some example embodiments of PMG 125 can be configured to periodically update one or more predictive models that are stored in the predictive models DB 122. Example of periods can comprise few weeks, between one to five weeks, two weeks for example. The updated predictive model can be stored in the predictive models DB 122.

Some example embodiments of PMG 125 can be configured to combine data of two or more types cargo in order to compute a predictive model for a recommended configuration. The two or more types of cargo need to have some similarity. Following are few examples of type of cargo panels of glass can combined with panels of marble; bananas and apples can be combined, etc.

FIG. 4A illustrates a flowchart with relevant processes of an example of method 400 that can be used for analyzing whether a loss that is related to a certain CSU is evident. Method 400 can be implemented by LDAU 126 (FIG. 1), for example. Method 400 can be initialized 402 by LDAU 126 (FIG. 1) upon receiving a new SLDR.

After initiation, process 400 may scan 404 the HDB 123 (FIG. 1) looking for entries that are related to similar journeys. The similarity can be based on locations, segments, carriers, type of cargo, dates, weather, etc. Those entries are copied 404 to a temporary database 2 (TempDB2). Next, TempDB2 can be transferred 406 to PMG 125 (FIG. 1) with instruction to generate, based on the data stored in TempDB2, a predictive model that can predict the probability for getting a Demand for Loss (DFL) at the end of the journey (Pe). This predictive model can also be used for predicting getting a DFL per each segment of that journey (Pi).

In some cases, the segments can be identified based on data from the Journey DB 111 (FIG. 1). In other cases the LDAU 126 (FIG. 1) can be configured to define the segments based on the reading from a timing sensor that is associated with that CSU, other embodiments of LDUA 126 can be configured to define the segments based on analyzing the readings of the sensors and compare them to an index that associate reading of different sensors to a certain type of carrier. Each type of carrier can be associated with unique range of vibration, acceleration, shocks, etc.

Upon getting the prepared predictive models, method 400 may start 410 a loop. Each cycle of the loop can be associated with one of the segments. At block 412 reading of the sensors that are related to the relevant segment are retrieved from the TempDB2 and are placed 412 in the predictive model. The calculated probability that a DFL may be filed is calculated 412 and be stored 414 as Pi in a table. In addition, the Pe of the entire journey is calculated and be stored too.

At block 420 a decision is made whether there is an additional segment. If 420 yes, then process 400 returns to block 410 for calculating the Pi of the next segment. If 420 there are no additional segments, then at block 422 each calculated probability for filing a DFL, which is stored in the temporary table, is compared 430 to a threshold Th2. Some example of embodiment may use a plurality of values of Th2. In some embodiment each value can be associated to a type of carrier, yet in other embodiment each value can be associated to a location (segment), in some embodiment each value of Th2 can be associated with the type of cargo, etc.

Next, a decision is made 430 whether the Pe or at least one of the values of the calculated Pi is higher than the value of the relevant threshold Th2. In some embodiments, Th2 can have different values for each segment or for Pe. If 430 yes, then a flag indicating that the relevant DFL is for real occurred damages can be set 434. In addition, the one or more suspected segments can be marked too 434. Then, the recommendation can be stored 436 in the history DB 123. In some embodiments, the recommendation can be added to the standardized-loss-demand report (SLDR) before transferring the SLDR to a human surveyor. The recommendation can be used as additional tool of the human surveyor while preparing his report. Then process 400 can be terminated 440.

If 430 the decision is that none of the calculated Pi nor Pe is bigger than the value of the relevant threshold Th2, then at block 432 a flag indicating that the relevant DFL is suspected as unjustified can be set 432 and process 400 proceeds to block 436. At block 436 the recommendation can be presented to the user and be stored in the history DB 123.

FIG. 4B schematically illustrates a flowchart showing relevant actions of a combined process 4000 for predicting one or more causes for certain damage. The combined process 4000 engages the PMG 125 (FIG. 1) and LDAU 126. PMG 125 (FIG. 1) may generate a predictive model that can predict one or more causes for certain damage. The generated model may be used by LDAU 126 (FIG. 1) in order to identify the one or more causes for the damage. Other example embodiments of the disclosed technique may use two separated processes. The first one can be a process for creating a predictive model per each cause and the second process can be implemented for pointing on suspected reasons for the damage.

After initiation 4002, process 4000 may scan 4004 the HDB 123 (FIG. 1) looking for entries that are related to journeys in which a DFL was filed and the entry also includes indication about the cause for that damage. In some example embodiments of the disclosed technique the entries may also comprise information about the setting (configuration) of environmental control devices that are associated with the relevant CSU. Those entries are copied 4004 to a temporary database 5 (TempDB5).

The TempDB5 can be transferred toward PMG 125 with an instruction 4006 to generate a predictive model or a classifier model per each cause from a group of reasons for damages. Upon getting the plurality of predictive models (one per each possible cause) a loop between block 4010 to 4040 can be initiated. Each cycle of the loop can be associated with a suspected cause for the damage.

At block 4012 readings of the sensors and other parameters that are related to the current demand for loss are placed in the predictive model that is related to the current cause (k) and the probability that the damage was generated by the current cause is calculated and be stored 4014 as Pk in a table.

Next the value of Pk is compared 4022 to a threshold TH3. Some embodiments of the disclosed technique may use a plurality of thresholds, one for each Pk. The different values can depend on the type of cause, on the type of cargo, etc. TH3 can be in the range of 10-60%, for example.

If 4030 the value of Pk is bigger than Th3, then in block 4034 an indication that the cause (k) is a suspected reason for the damage can be set. If 4030 the value of Pk is smaller than Th3, then in block 4032 an indication that the cause (k) is not a suspected reason for the damage can be set. Next, a decision is made 4040 whether there is additional suspected cause exist. If yes process 4000 returns to block 4010 and execute a next cycle of the loop.

If 4040 there are no additional causes, then at block 4042 the indications about the causes can be stored 4042 in the relevant entry of the HDB 123 (FIG. 1) and a report can be delivered 4042 to the user. Then process 4000 can be terminated 4050. In some example embodiments of block 4042 can be modified to include also an indication on the configuration of the environmental control devices.

In some example embodiments of the disclosed technique, process 4000 can be modified to include three or more indications. Indications such as but not limited to: a suspected cause, almost suspected a suspected cause, most likely suspected cause, etc.

FIG. 4C schematically illustrates a flowchart showing relevant actions of a process 4100. Process 4100 can be implemented for creating a model that can predict the extent-of-loss (EoL). Process 4100 can be executed by LDAU 126 (FIG. 1) in events that the LDAU determines that a “demand for loss” (DFL) is justify. In some embodiments process 4100 can be initiated 4102 by LDAU 126 (FIG. 1) as one of the actions that are executed at block 434 (FIG. 4A). In such embodiment, LDAU 126 may add the predicted EoL to the presented recommendation (block 436 FIG. 4).

After initiation 4102 process 4100 can scan 4104 the HDB 123 (FIG. 1) looking for entries (journeys) that are related to similar type of cargo and are associated with a justified DFL, which was marked by a human surveyor. This information can be obtained from journey DB 111 (FIG. 1), or from the HDB 123, for example. Further, those entries include an indication about the type of loss and indication about EoL that occur in that journey. Each found entry is copied 4104 to a temporary DB 7 (TempDB7). In some embodiments of process 4100 the copied entries 4104 may comprise indication about the used configuration of the environmental control devices that are associated with that journey.

The indication of the EoL can be expressed in percentages, or as a portion of the relevant freight or in ranks of damage. Example ranks can be: full damaged (1.0); high (0.75); medium (0.5); low (0.25) and no damage (0). In addition each copied entry may comprise an indication about the type of loss that occurred.

The type of damages for fruit may comprise frozen, ripening, rottenness, physical damages, etc. The type of damages for cars can be external damages to the body of the car, rust, etc. The type of damages for panels of marble or glass can be cracks, scratches, or a combination of the two. For those panels, the EoL can be the portion of a panel that was damaged, or the number of panels that were damaged divided by the total number of panels, or a combination of the two.

Next, at block 4106, LDAU 126 may send the TempDB7 toward PMG 125 (FIG. 1) with instruction to generate a predictive model for calculating the EoL for that type of damage and for that type of cargo. Per each type of loss, of the relevant type of cargo, PMG 125 may run a supervised machine learning algorithm on the data stored in TempDB7 in order to generate a model for predicting the EoL for that type of cargo and that type of damage. The method for defining a model for predicting the EoL can be similar to process 300 that is disclosed above for generating a predictive model with few modifications.

Following are few none limiting examples of supervised machine learning algorithm that can be used by an example of PMG 125 for generating a predictive model: logistic regression, linear regression, decision tree, random-forest, etc. A person with ordinary skill in the art will appreciate that the operation of PMG 125 can be used to predict the EoL as it is disclosed above in junction with FIG. 3.

At block 4110, LDAU 126 may wait to obtain an indication from PMG 125 (FIG. 1) that one or more predictive models for calculating the EoL are ready and be stored in DB 122 (FIG. 1). The number of the predictive models depends on the number of types of losses that are involved with the relevant type of cargo. Accordingly the one or more predictive models are fetched from DB 122.

Alternatively, at block 4110 LDAU 126 may retrieve from Predictive-Models DB 122 (FIG. 1) predictive models that are related to the relevant type cargo and the relevant type of damage.

Upon obtaining the one or more predictive models, LDAU 126 may start a loop between block 4120 and block 4130. Each cycle in the loop is associated with a certain type of damage that occurred to the relevant type of cargo of the relevant filed DFL. At block 4122 parameters that are relevant to the current journey are placed in the predictive model that is related to the current loss and the model is executed in order to deliver the prediction of the EoL. Along the present disclosure and the claims the verbs estimate and predict may be used interchangeably.

The parameters may comprise parameter's that can be retrieved from the relevant bill-of-lading (BoL); parameters that are related the segment, in which an example of LDAU 126 determined that the damage was occurred in that segment of the journey, as it is disclosed above in conjunction with block 434 FIG. 4A; telemetric parameters that were obtained by the sensors during the relevant segment of the journey; GPS information; in cases in which the relevant CSU includes an alarm device, then one of the parameters can be whether the alarm device was activated during the suspected segment of the journey, etc. The telemetric parameters may comprise: temperature, relative humidity, acceleration, vibration, etc., In some embodiments of the disclosed technique, the parameters may comprise the configuration of the environmental control devices that are related to that BoL.

The calculated 4122 value of the predicted EoL can be in the range between zero to one or between 0% and 100%. The predicted value of the EoL, for the current type of damage in the current case, can be stored 4124 in the HDB 123 (FIG. 1) and process 4100 may determine 4130 whether additional type of damage is associated with the current case, the current DFL. If 4130 there is additional type of damage, then process 4100 may start 4120 a new cycle of the loop in order to predict the EoL which is related to the next type of damage.

If 4130 there is no additional type of loss, then process 4100 may deliver 4132 a report in which the predicted values of the EoL, per each type of loss, are presented. In some embodiment the report may comprise information about the used configuration. Then, process 4100 can be terminated 4140.

FIG. 4D schematically illustrates a flowchart showing relevant actions of a process 4200. Process 4200 can be implemented by an example LDAU 126 (FIG. 1) for predicting the liability that is associated with a certain DFL. In some embodiments process 4200 can be initiated 4202 by LDAU 126 (FIG. 1) after determining the EoL. The value of the predicted liability can be added to the presented recommendation (block 436 FIG. 4) of the LDAU.

At block 4202 the relevant BoL can be fetched from the HDB 123 (FIG. 1), for example. Based on the BoL process 4200 can retrieve the value of the cargo, the number of units in a CSU, the weight of each unit, etc. In case that the CSU comprises a single unit then the total weight of the cargo can be used. At block 4206 the total cost that is involved in filing the DFL can be added. The total cost of filing can comprise the cost of a human surveyor, the cost of an attorney, etc.

Next, the entry of the relevant journey in the HDB 123 (FIG. 1) can be scanned 4208 looking for the segment that was pointed by the LDAU as the segment in which the damage occurred, The segment, which was pointed at block 434 (FIG. 4A). The relevant convention policy that is related to that segment can be fetched 4210 and accordingly the maximum liability can be calculated 4212 and be stored as MaxLi.

At block 4214 the actual liability (AcLi) can be calculated based on the value of the EoL that was predicted in block 4132 DIG. 4B. An example of process 4200 can calculate the AcLi as the product of the value of the cargo by the EoL plus the cost of filing the DFL. Next the value of the MaxLi can be compared 4216 to the value of AcLi and a decision is made 4220 whether MaxLi is equal or greater than AcLi. If yes, then at block 4222 the AcLi is presented as the liability of the current justified DFL and process 4200 can be terminated 4230. If 4220 the value of AcLi is greater than the value of MaxLi, then at block 4224 the MaxLi is presented as the liability of the current DFL and process 4200 can be terminated 4230.

In some example embodiment of process 4200, block 4216 can be modified to present the two values, the value of MaxLi and the value of the ActLi and let the user to determine which value to use. Such embodiment process 4200 can be terminated after the modified block 4216.

Referring now to FIG. 5A that illustrates a flowchart showing relevant processes that can be used by method 500. Method 500 can be implemented by an example of operational-recommending-unit (ORU) 128 (FIG. 1) for calculating the impact of each Parameter-Of-Interest (POI) on the journey. The POIs could be locations along alternative routes between the origin and the destination, cost of the journey for the carrier, duration of the journey, In some example embodiments of the disclosed technique the POI can reflect a certain configuration of one or more environmental control devices that are associated with the relevant CSU, etc.

Method 500 can be implemented per a defined target. The defined target can be values of one or more features, which are critical to the condition of the cargo. For example, the range of temperatures, acceleration above a certain threshold, vibration (amplitude and frequency), the concentration of CO2, O2, cost, etc. In addition, the defined target can be the cost of journey for the carrier, the duration of the journey, etc.

Process 500 can be initiated 502 by obtaining a request from a user, for example, to get a recommendation for a route from an original to a destination. Alternatively, the user may request to get a recommended configuration of the environmental control devices. The user may define the target that is relevant for that cargo and a list of one or more risk factors that are relevant for the recommendation. The user can be a shipper, a consignee, a carrier, etc.

At block 504 the defined target is obtained and process 500 may scan the historical DB 123 (FIG. 1) looking for entries that are related to alternative journeys between the relevant two ends (the origin and the destination of that journey). Those entries can be copied to a temporary database 3 (TempDB3). Then a loop can be initiated between block 506 to block 520. Each cycle in the loop can be associated with a POI.

At block 506 the data of TempDB3 can be divided into two groups. The first group contains journeys that include the current POI and the second group contains journeys that do not comprise the current POI.

Next, a predictive model can be generated 508 per each group and per each defined target. One predictive model can predict the probability that the defined target can be reached in a journey with that POI and the other predictive model can predict the probability that the define target can be reach in an alternative journey without that POI. At block 510 the probability to reach the defined target with the current POI can be calculated using the appropriate generated predictive model. In addition, the probability to reach the defined target in a route without the current POI can be calculated 510 by using the other generated predictive model.

The impact of the current POI on the define target can be calculated 512 as the difference between the two values of the probabilities that were calculated in block 510. At block 514 the statistical error of the prediction can be calculated. Some example embodiments of the disclosed technique may use standard deviation as the statistical error. Other embodiments may use other type of statistical error. The impact and the statistical error that related to the current POI can be stored 516 in a memory device that is associated with ORU 128 (FIG. 1).

Next, a decision is made 520 whether additional POI exists. If 520 there is additional POI, then the next POI is selected 522 and process 500 returns to block 506 for calculating the impact of the next POI. If 520 there is no additional POI, then process 500 may present 524 the stored calculated impacts and the statistical errors that were calculated per each POI.

In an example embodiment of the disclosed technique, in which the POI is a recommended configuration, from a plurality of possible configurations, of the environmental control devices, then the define target can be the temperature, humidity, the concentration of CO2, the concentration of O2, etc. in the CSU.

The presentation can be executed as a table in which the rows represent alternative journeys between the original and the destination and each column represents a POI along that journey. The impact and the statistical error can be written in the appropriate cells of that table. The table can be printed or displayed 524 to the user and process 500 can be terminated 526.

In embodiments of process 500 that is used to define a recommended configuration of environmental control devices that are related to the relevant CSU and the relevant type of cargo, the presentation the presentation can be executed as a table in which the rows represent defined targets (temperature, humidity, etc.) and each column represents a POI (a configuration). The impact and the statistical error can be written in the appropriate cells of that table. The table can be printed or displayed 524 to the user and process 500 can be terminated 526.

FIG. 5B schematically illustrates a flowchart of method 5000 that can be implemented by an example of operational-recommending-unit (ORU) 128 (FIG. 1). Method 5000 can be executed per a define set of filters and per a list of one or more of risk factors. The set of filters may comprise of a combination of: type of cargo, location, season of the year, type of CSU including information regarding environmental control devices that are associated with that CSU, etc. The list of risk factors can comprise a plurality of possible risks. An example of a list can comprise: temperature above 50 Celsius degrees for at least 30 min; acceleration above 8 g, humidity above 70%, etc.

Process 5000 can be initiated 5002 by obtaining a request from a user, for example, to get a recommendation for handling a certain cargo. The user may define 5004 the relevant set of filters and the list of risk factors. The user can be a shipper, a consignee, a carrier, etc.

At block 5006 the HDB 123 (FIG. 1) can be scanned and entries that are associated with the defined set of filters can be copied to a temporary DB 6 (TempDB6). In some embodiments a link per each entry of those entries is copied to TempDB6. At block 5008 the TempDB6 can be scanned and entries that are not associated with occurred damages can be removed from TempDB6.

Next a loop between block 5010 and 5020 can be initiated. Each cycle of the loop can be associated with a certain risk factor from the obtained list of risk factors. At block 5012 the TempDB6 can be transferred toward a queue of PMG 125 (FIG. 1) with a request to generate a predictive model that can predict the contribution of the current risk factor to the occurred damage.

Upon obtaining the requested predictive model from PMG 125, the contribution of the current risk factor and the statistical error of the prediction can be calculated 5014. The calculated probability and the statistical error can be stored 5018 in a memory device that is associated with ORU 128 (FIG. 1). Next a decision is made 5020 whether additional risk factors are included in the list of risk factors. If 5020 yes process 400 returns to block 5010 for handling the next risk factor. If 5020 not, the stored results can be presented 5024 to the user.

Some example embodiments may use 5024 a table in which each row is associated with a define set of filters (a configuration) and each column is associated with a risk factor. Thus, each cell of the table can present 5024 the calculated probability to reach the relevant risk factor for the relevant set of filters as well as the associated statistical error. After presenting the results process 5000 can be terminated 5026. Thus, a recommended configuration can be the configuration (set of filters) that is associated with the lowest probability to reach the relevant risk factor.

FIG. 6A is a flowchart that illustrates an example process 600 that can be implemented by an example of operational-recommending-unit (ORU) 128 (FIG. 1) for predicting a recommended-configuration. The recommended-configuration is for a certain CSU that carries a certain type of cargo. Process 600 is based on the Wisdom-Of-The-Crowd (WOTC). Method 600 can be initiated 602 by ORU 128 (FIG. 1) and be executed per a defined type of cargo and defined CSU.

In order to increase the number of observations per a certain type of cargo, a user may define 604 a family of products, which are similar to the current cargo. For example, in case that the current cargo is oranges, the family may comprise lemon, grapefruit, etc. In case that the current cargo is wheat, the family may comprise barley, corn, etc. In case that the cargo is meat of beef, the family may comprise meat of pork, meat of sheep, etc. Per each family two or more configuration can be defined 604. Each configuration can comprise a group of settings, setting of the required temperature, the required humidity, the required concentration of O2 or CO2, etc.

At block 605 the ORU 128 (FIG. 1) can scan the HDB 123 looking for entries that are related to the type of cargo that belongs to the defined family. Those entries can be copied to a temporary DB 9 (TempDB9). Next TempDB9 can be scanned 608 in order to remove entries that are not associated with an initial configuration of the environmental control devices. Along the present disclosure and the claims the terms “initial configuration” and “requested configuration” can be used interchangeably.

Next a loop can be initiated between block 610 and block 620. Each cycle in the loop can be associated with a configuration (a group of settings). At block 612 the TempDB9 may be transferred to PMG 125 (FIG. 1) with an instruction to generate a predicting model, which can predict the probability that the current configuration will be used. Upon obtaining, the generated predictive model, from PMG 125, The ORU 128 can calculate 614 the probability and the statistical error that the current configuration will be used.

The calculated probability and the statistical error can be stored 618 in ORU DB 129 (FIG. 1) and process 600 may check 620 if there is additional configuration (a group of settings). If yes, then process 600 return to block 610 for handling the next configuration. If 620 there is no additional configuration, then the configuration that has the highest probability to be used (the popular configuration) is presented 622 and can be presented in order to calibrate the environmental control devices and process 600 can be terminated 630.

FIG. 6B is a flowchart that illustrates an example process 6100 that can be implemented by an example of operational-recommending-unit (ORU) 128 (FIG. 1) for recommending a configuration that has low probability to be associated with a damage. The calculated probability is related to a certain CSU and for the type of cargo that is currently associated with that CSU. Method 6100 can be initiated 6102 by ORU 128 (FIG. 1) and be executed per a CSU before starting the journey or a segment of that journey.

In order to increase the number of observations per a certain type of cargo, a user may define 6104 a family of products, which are close to the current cargo. For example, in case that the current cargo is oranges, the family may comprise lemon, grapefruit, etc. In case that the current cargo is wheat, the family may comprise barley, corn, etc. In case that the cargo is meat of beef, the family may comprise meat of pork, meat of sheep, etc.

Per each family, two or more configurations can be defined 6104. Each configuration can comprise a group of settings. Settings of environmental control devices that can generate the required temperature, the required humidity, the required concentration of O2 or CO2, etc.

At block 6106 the ORU 128 (FIG. 1) can scan the HDB 123 looking for entries that belong to the current family. Those entries can be copied to a temporary DB 10 (TempDB10). Next TempDB10 can be scanned 6108 in order to remove entries that are not associated with initial configuration of the environmental control devices.

Next, a loop can be initiated between block 6110 and block 6120. Each cycle in the loop is associated with a configuration (a group of settings). At block 6112 the TempDB10 may be transferred to PMG 125 (FIG. 1) with an instruction to generate a predicting model, which can predict the probability that loss may occur for the current group of settings (current configuration). Along the present disclosure and the claims the terms configuration and group-of-settings can be used interchangeably. Some example embodiments of process 6100 may first search the predictive models DB 122 looking for one or more predictive models that can be used for the relevant case. If such one or more predictive models exist in the predictive models DB 122, then process 6100 can fetch and use those predictive models instead of instructing PMG 125 to generate new models.

Upon obtaining, the one or more predictive models, the ORU 128 can calculate 6114 the probability and the statistical error that damage may occur while using the current configuration. The calculated probability and the statistical error can be stored 6116 in ORU DB 129 FIG. 1 and process 6100 may check 6120 whether additional configuration (a group of settings) exists. If yes, then process 6100 return to block 6110 for handling the next configuration.

If 6120 there is no additional configuration, then the configuration that has the lowest probability to be associated with a damage can be presented 6122 or be printed and be used for calibrating the environmental control devices. Then process 6100 can be terminated 6130.

FIG. 6C schematically illustrates a flowchart showing relevant processes of a method 6200 that can be implemented by an example of operational-recommending-unit (ORU) 128 for presenting a recommended configuration to a shipper. Process 6200 can be initiated 6202 by a user who wishes to get a recommendation for a configuration of a certain CSU that carries a certain type of cargo.

At block 6204 information from a BoL of the relevant CSU is fetched. The information can include a requested configuration to be used for the relevant CSU. The requested configuration can be stored 6206. Next process 6200 may select and fetch 6208, from predicting models DB 122 (FIG. 1), a predicting model that was generated for predicting the recommended configuration for the current CSU and the current type of cargo.

Fetch from the BoL the values of the required variables (temperature, humidity, pressure, the required concentration of O2 or CO2, etc) and place those values 6210 in the fetched predicting model and calculate 6212 the predicted system configuration for the current CSU with the current cargo.

The system recommendation configuration can be presented 6214 with the requested configuration and allowing the user to select 6218 the user's preferred configuration. Then process 6200 can be terminated 6230.

FIG. 7 schematically illustrates a flowchart showing relevant processes that can be implemented by an example embodiment of method 700. Method 700 can be initiated 702 by an example of a risk-analyzer unit (RAU) 127 (FIG. 1) in order to determine the risk that is involved in a certain journey for a certain type of cargo.

At block 704 method 700 may lead the user to load to the RAU 127 with the features of the journey. The features of the journey may comprise cargo information, the locations of the original and destination, carriers, period of the year, etc. The cargo information may comprise sensitivity to shocks, sensitivity to vibrations (amplitude and frequency), sensitivity to temperature, sensitivity to humidity, sensitivity to water, etc.

Next, information, which is relevant to the certain journey and the certain cargo, can be obtained 706 from the external DBs (DB 111 to DB 118 of FIG. 1). The information can comprise information about the weather, possible storms, the type of CSU, etc. In addition common readings from the relevant one or more sensors (sensors similar to the sensors that are associated with the current CSU) can be retrieved from the historical DB 123 (FIG. 1).

At block 708 a predictive model, for predicting whether a loss is likely to be demand, can be fetched from predictive model DB 122. The fetched predictive model was generated for a similar journey and a similar type of cargo. The similarity can be based on locations, segments, carriers, type of cargo, dates, weather, etc. Next the collected features that were obtained in blocks 704 and 706 can be placed in the fetched predictive model in order to calculate 710 the probability for damage in the entire journey and per each of the relevant segments.

Then, the results can be presented 712 by a table, for example, in which the first row represent the entire journey and the following rows represent one or more segments of that journey. The column represents the calculated risk. Thus, each cell in the table stores the risk that is associated with the relevant location. The table can be printed or displayed 712 to the user and process 700 can be terminated 720.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons having ordinary skill in the art that the present invention is not limited by what has been particularly shown and described herein above. Rather the scope of the invention is defined by the claims that follow.

What is claimed is:

1. A computer-readable non-transitory medium containing executable instructions that when executed cause a processor at an operational-recommending-unit (ORU):
i. to obtain information regarding one or more environmental-control-devices that are associated with a cargo-shipping-unit (CSU) that carries a certain type of cargo;
ii. to obtain information regarding environmental conditions which are required by the certain type of cargo;
iii. to determine a recommended configuration of the one or more environmental-control-devices; and
iv. to present the recommended configuration of the one or more environmental-control-devices,
wherein the ORU is communicatively coupled with one or more databases (DBs).

2. The computer-readable non-transitory medium of claim 1, wherein information regarding environmental conditions which are required by the certain type of cargo comprises a range of concentration of O2.

3. The computer-readable non-transitory medium of claim 1, wherein information regarding environmental conditions which are required by the certain type of cargo comprises a range of temperature.

4. The computer-readable non-transitory medium of claim 1, wherein the executable instructions to determine the recommended configuration causes the processor to determine which configuration is popular among previously used configurations.

5. The computer-readable non-transitory medium of claim 4, wherein the executable instructions to determine the recommended configuration further comprises instructions that cause the processor to:
a. scan an historical DB (HDB) looking for entries that are associated with similar types of cargo and similar types of CSU;
b. copy the entries that are associated with the similar types of cargo and the similar types of CSU to a temporary DB;
c. observe the temporary DB looking for a popular configuration among one or more configurations that are used in journeys that are stored in the temporary DB; and
d. define the popular configuration as the recommended configuration.

6. The computer-readable non-transitory medium of claim 5, wherein similar types of cargo comprises a family of products that have similar features.

7. The computer-readable non-transitory medium of claim 6, wherein one family of products comprises oranges, lemons, and grapefruits.

8. The computer-readable non-transitory medium of claim 6, wherein another family of products comprises wheat, barley and corn.

9. The computer-readable non-transitory medium of claim 1, wherein the executable instructions to determine the recommended configuration further comprises instructions that cause the processor to:
a. scan an historical DB (HDB) looking for entries that are associated with similar types of cargo and similar types of CSU;
b. copy the entries that are associated with the similar type of cargo and the similar type of CSU to a temporary DB;
c. observe the temporary DB looking for one or more configurations that were used in journeys that are stored in the temporary DB;
d. predict, per each configuration from the one or more configurations, the probability that damage may occur; and
e. define the configuration that is associated with a lowest probability that damage may occur as the recommended configuration.

10. The computer-readable non-transitory medium of claim 9, wherein the executable instructions to predict, per each configuration from the one or more configurations, the probability that damage may occur is implemented by using one or more predictive models that were generated from information that is related to journeys that are stored in the temporary DB.

11. The computer-readable non-transitory medium of claim 10, wherein per each journey that is stored in the temporary DB the information comprises the type of CSU; the type of cargo; the used configuration, and an indication whether damage has occurred.

12. The computer-readable non-transitory medium of claim 9, wherein similar types of cargo comprises a family of products that have similar features.

13. The computer-readable non-transitory medium of claim 12, wherein one family of products comprises oranges, lemons, and grapefruits.

14. The computer-readable non-transitory medium of claim 12, wherein another family of products comprises wheat, barley and corn.

15. A system comprising:
a. an operational-recommending-unit (ORU) that is communicatively coupled with one or more databases (DBs);
b. wherein the ORU comprises a processor that is configured to:
i. obtain information regarding one or more environmental-control-devices that are associated with a cargo-shipping-unit (CSU) that carries a certain type of cargo;
ii. obtain information regarding environmental conditions which are required by the certain type of cargo;
iii. determine a recommended configuration of the one or more environmental-control-devices; and
iv. present the recommended configuration of the one or more environmental-control-devices.

16. The system of claim 15, wherein information regarding environmental conditions which are required by the certain type of cargo comprises a range of concentration of O2.

17. The system of claim 15, wherein information regarding environmental conditions which are required by the certain type of cargo comprises a range of temperature.

18. The system of claim 15, wherein the processor is configured to determine the recommended configuration by further comprising determining which configuration is popular among previously used configurations.

19. The system of claim 18, wherein the processor is configured to determine the recommended configuration by further comprising that the processor is configured to:
a. scan an historical DB (HDB) looking for entries that are associated with similar type of cargo and similar type of CSU;
b. copy the entries that are associated with similar types of cargo and similar types of CSU to a temporary DB;
c. observe the temporary DB looking for a popular configuration among one or more configurations that are used in journeys that are stored in the temporary DB; and
d. define the popular configuration as the recommended configuration.

20. The system of claim 19, wherein similar types of cargo comprises a family of products that have similar features.

21. The system of claim 20, wherein one family of products comprises oranges, lemons, and grapefruits.

22. The system of claim 20, wherein another family of products comprises wheat, barley and corn.

23. The system of claim 15, wherein the processor is configured to determine the recommended configuration by further comprising that the processor is configured to:
a. scan an historical DB (HDB) looking for entries that are associated with similar types of cargo and similar types of CSU;
b. copy the entries that are associated with the similar types of cargo and the similar types of CSU to a temporary DB;
c. observe the temporary DB looking for one or more configurations that were used in journeys that are stored in the temporary DB;
d. predict, per each configuration from the one or more configurations, the probability that damage may occur; and
e. define the configuration that is associated with a lowest probability that damage may occur as the recommended configuration.

24. The system of claim 23, wherein the processor is configured to predict, per each configuration, the probability that damage may occur by the processor being configured to use one or more predictive models that were generated from information that is related to journeys that are stored in the temporary DB.

25. The system of claim 24, wherein, per each journey that is stored in the temporary DB, the information comprises the type of CSU, the type of cargo, the used configuration, and an indication whether damage has occurred.

26. The system of claim 23, wherein similar types of cargo comprise a family of products that have similar features.

27. The system of claim 26, wherein one family of products comprises oranges, lemons, and grapefruits.

28. The system of claim 26, wherein one family of products comprises wheat, barley and corn.
